(19) United States
(12) Patent Application Publication
(10) Pub. No.: US 2026/0179262 A1
(43) Pub. Date: Jun. 25, 2026

(54) MULTI-LAYER SPARSE CONTENT HANDLING FOR SPLIT AR/MR

(71) Applicant: QUALCOMM Incorporated, San Diego, CA (US)

(72) Inventors: Chirag Maheshkumar PUJARA, Bangalore (IN); Tanu SHARMA, Najafgarh (IN)

(21) Appl. No.: 18/991,302

(22) Filed: Dec. 20, 2024

(51) Int. Cl. G06T 11/00; G06T 9/00

(52) U.S. Cl. CPC G06T 11/00; G06T 9/00; G06T 2210/12

(57) ABSTRACT

This disclosure provides systems, devices, apparatus, and methods, including computer programs encoded on storage media, for multi-layer sparse content handling for split AR/MR. A display processor may generate an atlas of sparse layers based on a merger of each of the sparse layers that include sparse content. The sparse layers may be associated with image content. The display processor may encode the atlas in a first encoding session. The display processor may output the encoded atlas as an encoded representation of the image content. A display may receive an encoded atlas of sparse layers based on a merger of each of the set of sparse layers that include sparse content. The sparse layers may be associated with image content. The display may decode the encoded atlas in a first decoding session to obtain the sparse layers. The display may output the sparse layers as a representation of the image content.

### TECHNICAL FIELD

The present disclosure relates generally to processing systems, and more particularly, to one or more techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for display processing may utilize individual render and composite operations for layers of images with sparse content, but may not address the inefficient memory access utilization and data throughput caused by encodes/decodes and composites associated with such individual handling. There is a need for improved techniques for rendering and compositing layers with sparse content, such as in split extended reality (XR) systems such, but not limited to, split augmented reality (AR) / mixed reality (MR) (AR/MR) systems.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor is configured to: generate an atlas of a set of sparse layers based on a merger of each of the set of sparse layers that include sparse content, where the set of sparse layers is associated with image content; encode the atlas in a first encoding session, and output the encoded atlas as an encoded representation of the image content.

In another aspect of the disclosure, a method, a computer-readable medium, and an apparatus are provided. The apparatus includes a memory; and a processor coupled to the memory and, based on information stored in the memory, the processor is configured to: receive an encoded atlas of a set of sparse layers based on a merger of each of the set of sparse layers that include sparse content, where the set of sparse layers is associated with image content, decode the encoded atlas in a first decoding session to obtain the set of sparse layers, and output the set of sparse layers as a representation of the image content.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example image or surface in accordance with one or more techniques of this disclosure.

FIG. 4 illustrates an example display framework including a display processor and a display in accordance with one or more techniques of this disclosure.

FIG. 5 illustrates an example of image content for AR/MR, in accordance with one or more techniques of this disclosure.

FIG. 6 illustrates an example of an atlas of sparse layers, in accordance with one or more techniques of this disclosure.

FIG. 7 illustrates an example of generating an atlas of sparse layers, in accordance with one or more techniques of this disclosure.

FIG. 8 illustrates an example of a server-client pipeline for utilizing an atlas of sparse layers, in accordance with one or more techniques of this disclosure.

FIG. 9 illustrates examples of layer composition for an atlas of sparse layers, in accordance with one or more techniques of this disclosure.

FIG. 10 is a call flow diagram illustrating example communications between a display processor and a display in accordance with one or more techniques of this disclosure.

FIG. 11 is a flowchart of an example method of display processing in accordance with one or more techniques of this disclosure.

FIG. 12 is a flowchart of an example method of display processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit. As used herein, the term “augmented reality (AR)” may refer to the technology that overlays digital content on top of the real world through, a headset, a mobile device display, extended reality (XR) display glasses, an automotive display, etc. As used herein, the term “virtual reality (VR)” may refer to a virtual environment to create believable experiences for a user, including immersive experiences in a real-life situation or a creative imaginary experience. As used herein, the term “mixed reality (MR)” may refer to a combination of both AR and VR together which may capture real-world experience through a series of cameras and/or sensors and then project the experience on a display before the eyes of a user, where virtual objects may be seamlessly integrated into reality for user experiences. As used herein, the term “extended reality (XR)” may refer to any of the set of AR, VR, and MR, including the “metaverse” which may refer to the ecosystem revolving around XR. As used herein, the term “split AR/MR system” may refer to a system in which rendering of image content is performed by a companion/host/server device (e.g., a mobile device, etc.), and displaying image content is performed by a viewer/client device (e.g., a headset, a mobile device display, extended reality (XR) display glasses, an automotive display, etc.). As used herein, the term “atlas” may refer to a single representation/merger of a set of layers, e.g., a set of layers with sparse content, and associated layer information. As used herein, the term “sparse content” may refer to virtual content of a layer that occupies an amount of the layer less than a threshold. As used herein, the term “bounding box” may refer to a geometry, e.g., a quadrilateral/rectangle, that bounds a virtual object during creation of an atlas of sparse layers. As used herein, the term “margin” may refer to a scalar or other value that is added to height and/or width dimensions of a bounding box. As used herein, the term “metadata” may refer to data that includes information about other data, generally, such as but not limited to, data that provides information associated with layer data, margin data, bounding box data, etc., herein. As used herein, the terms “encoding session” and “decoding session” may refer to single, atomic encoding/decoding procedure from initialization of an encoder/decoder to a closing of the encoder/decoder, e.g., an encoding/decoding procedure of a single layer associated with image content.

In split AR/MR system cases, there may generally be sparse content with few layers, and managing such sparse layers/content as a separate layers after rendering up to display may increase memory accesses (e.g., for double data rate (DDR) memory) and may take multiple sessions in encoding/decoding, as well as multiple accesses via Bluetooth™ (Bluetooth is a trademark of the Bluetooth Special Interest Group (SIG)), Wi-Fi™ (Wi-Fi is a trademark of the Wi-Fi Alliance), etc. Current techniques for display processing may utilize individual render and composite operations for layers of images/image frames with sparse content, but may not address the inefficient memory access utilization and data throughput caused by encodes/decodes and composites associated with such individual handling. Further, this type of naïve handling of sparse content for layers leads to increased power consumption for memory and processors, increased encoder concurrency, and increased power for transmission/provision of rendered content for display. There is a need for improved techniques for rendering and compositing layers with sparse content, such as in split XR systems such, but not limited to, split AR/MR systems.

Aspects herein provide for merging a number the layers having sparse content (e.g., a set of layers, all layers, and/or the like) into a single atlas, such as an atlas of sparse layers, after rendering. Aspects enable identifying bounding boxes for virtual objects (e.g., either provided by an application, such a game engine, etc., or detected using a deep learning (DL) model(s)) of all the sparse layers, and grouping overlapping bounding boxes of a layer into one bigger bounding box. Aspects also enable the creation of an atlas of sparse layers using the bounding boxes of all the layers while keeping a defined margin (e.g., approximately a smallest coding block size) between neighboring bounding boxes, and the creation of an appropriate/a corresponding occupancy map of the virtual objects in the layers. Aspect also enable the creation of metadata containing layer and bounding box information, and the creation of three encoder sessions for a Red (R), Green (G), Blue (B), Alpha Channel (A) (RGBA) atlas with lossy/lossless compression, for a depth map atlas with lossy/lossless compression, and for an occupancy map of the atlas with lossless compression, as well as creation of the metadata with lossless compression, e.g., using an entropy encoding. In aspects, a vertex shader may be configured, for each pixel of output texture, to find a mapping to all layers using respective transformation matrices, and a fragment shader may be configured to iterate over layers according to their composition order and blend color.

Accordingly, aspects enable layers with sparse content to be merged/rearranged into a single atlas (post-rendering) at the server side that may be handled as a single frame, rather than multiple sparse frames. Thus, aspects reduce DDR memory access bandwidth and reduce the number of encode/decode sessions for multiple layers with sparse content to a single encode/decode session (e.g., a reduction in session overhead). Additionally, as the image content/data for an atlas of sparse layers is encoded at one time and transmitted/provided for a display, e.g., via Wi-Fi™ or Bluetooth™, transmission/provision power is reduced as all data for the layers merged in the atlas may be transmitted/provided in a single access/session. Similarly, at the client side, software overhead for de-packetization is reduced, as is multi-session decoding of multiple layers with sparse content (e.g., a single decode session of the atlas may be performed instead).

The examples described herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

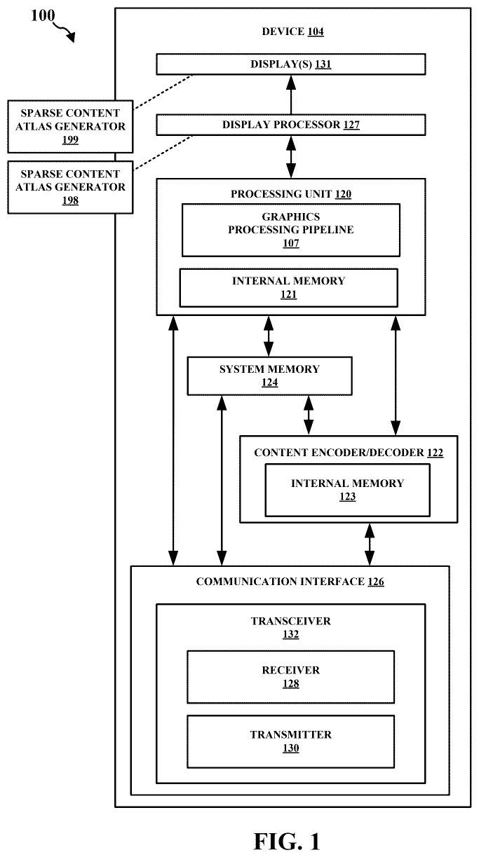

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a sparse content atlas generator 198 configured to generate an atlas of a set of sparse layers based on a merger of each of the set of sparse layers that include sparse content, where the set of sparse layers is associated with image content, to encode the atlas in a first encoding session, and to output the encoded atlas as an encoded representation of the image content. The sparse content atlas generator 198 may also be configured to encode an occupancy map in a different encoding session than the first encoding session. In certain aspects, the display(s) 131 may include a sparse content atlas generator 199 configured to receive an encoded atlas of a set of sparse layers based on a merger of each of the set of sparse layers that include sparse content, where the set of sparse layers is associated with image content, to decode the encoded atlas in a first decoding session to obtain the set of sparse layers, and to output the set of sparse layers as a representation of the image content. The sparse content atlas generator 199 may also be configured to decode an encoded occupancy map in a different decoding session than the first decoding session. Although the following description may be focused on display processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

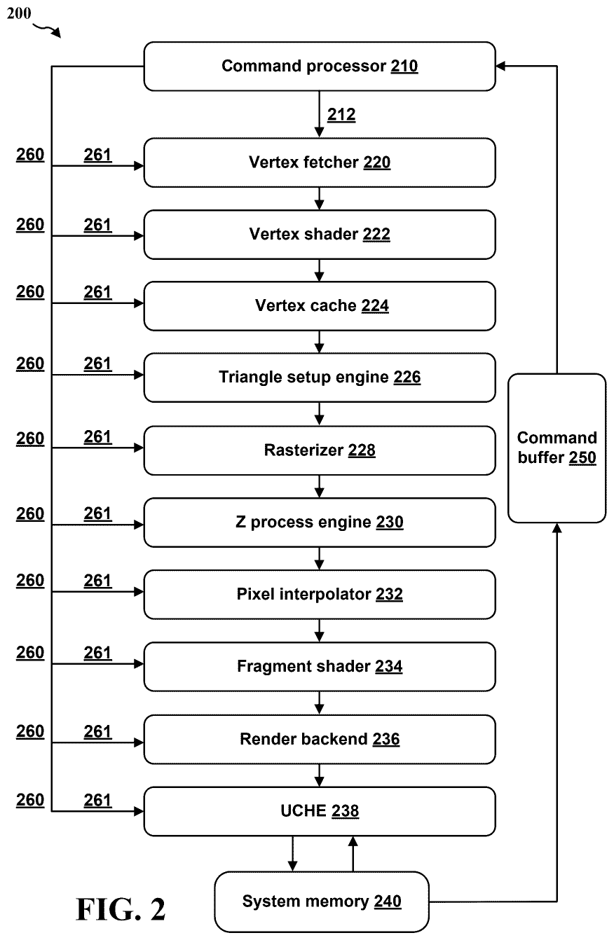

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

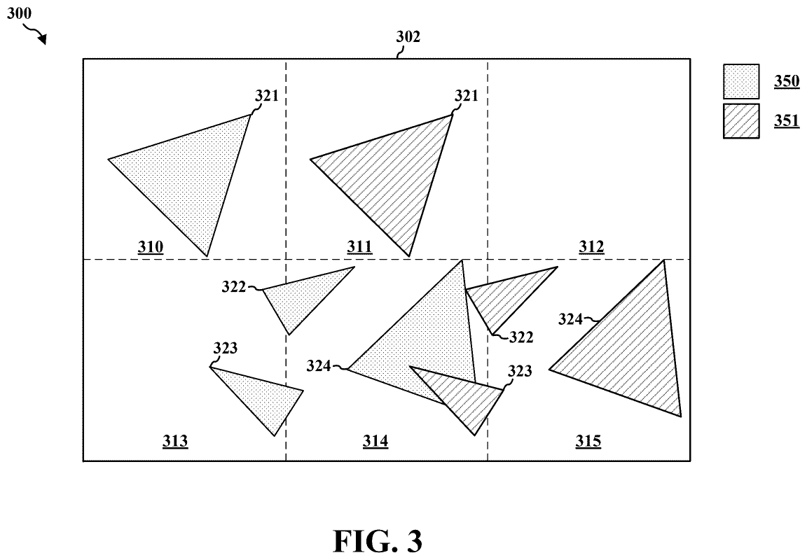

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

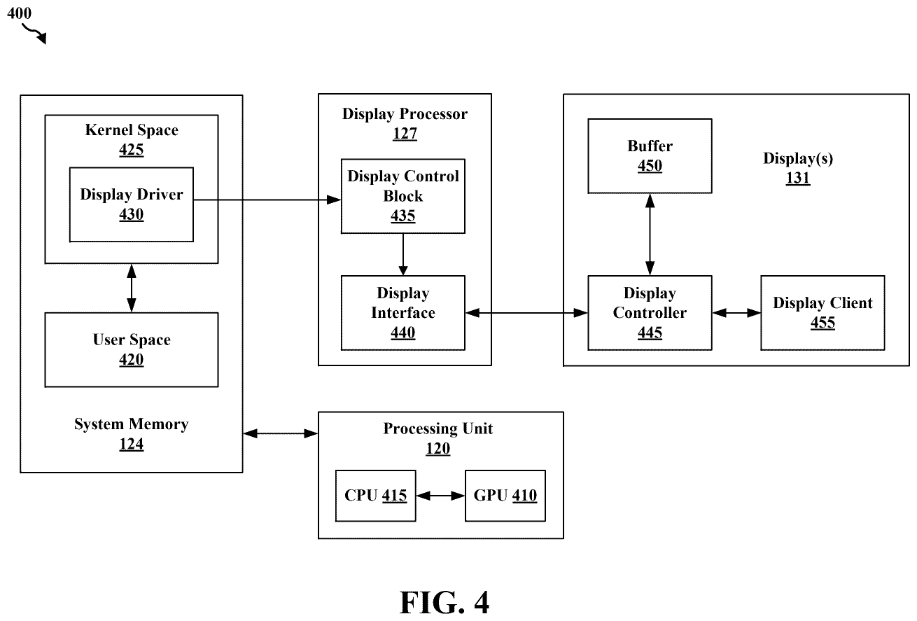

FIG. 4 is a block diagram 400 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 410 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 410 may be controlled based on one or more graphics processing commands provided by a CPU 415. The CPU 415 may be configured to execute multiple applications concurrently. In some cases, each of the concurrently executed multiple applications may utilize the GPU 410 simultaneously. Processing techniques may be performed via the processing unit 120 output a frame over physical or wireless communication channels.

The system memory 124, which may be executed by the processing unit 120, may include a user space 420 and a kernel space 425. The user space 420 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 425 may further include a display driver 430. The display driver 430 may be configured to control the display processor 127. For example, the display driver 430 may cause the display processor 127 to compose a frame and transmit the data for the frame to a display.

The display processor 127 includes a display control block 435 and a display interface 440. The display processor 127 may be configured to manipulate functions of the display(s) 131 (e.g., based on an input received from the display driver 430). The display control block 435 may be further configured to output image frames to the display(s) 131 via the display interface 440. In some examples, the display control block 435 may additionally or alternatively perform post-processing of image data provided based on execution of the system memory 124 by the processing unit 120.

The display interface 440 may be configured to cause the display(s) 131 to display image frames. The display interface 440 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 450.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 450. For example, when a Vsync pulse is generated, the display processor 127 may output new graphical content to the buffer 450. Thus, generation of the Vsync pulse may indicate that current graphical content has been rendered at the buffer 450.

Frames are displayed at the display(s) 131 based on a display controller 445, a display client 455, and the buffer 450. The display controller 445 may receive image data from the display interface 440 and store the received image data in the buffer 450. In some examples, the display controller 445 may output the image data stored in the buffer 450 to the display client 455. Thus, the buffer 450 may represent a local memory to the display(s) 131. In some examples, the display controller 445 may output the image data received from the display interface 440 directly to the display client 455.

The display client 455 may be associated with a touch panel that senses interactions between a user and the display(s) 131. As the user interacts with the display(s) 131, one or more sensors in the touch panel may output signals to the display controller 445 that indicate which of the one or more sensors have sensor activity, a duration of the sensor activity, an applied pressure to the one or more sensor, etc. The display controller 445 may use the sensor outputs to determine a manner in which the user has interacted with the display(s) 131. The display(s) 131 may be further associated with/include other devices, such as a camera, a microphone, and/or a speaker, that operate in connection with the display client 455.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 410 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

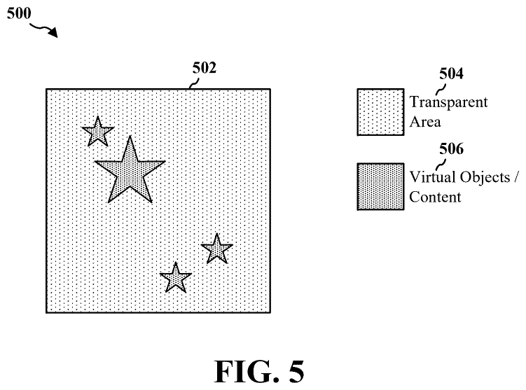

FIG. 5 illustrates a diagram 500 showing an example of image content for AR/MR, in accordance with one or more techniques of this disclosure. As described herein, AR/MR image content may be sparse in layers. That is, much of a layer associated with image content may be empty of virtual objects. As shown in diagram 500, an image frame 502 may include virtual objects/content 506, which may comprise a number of layers. The image frame 502, where the virtual object(s)/content 506 are absent, may comprise transparent area 504.

In some scenarios, the virtual object(s)/content 506 may comprise sparse content of the layer(s) in which the virtual object(s)/content 506 is included. As one example, an amount of the virtual object(s)/content 506 that does not meet a threshold (e.g., the amount is less than, or is less than or equal to, the threshold) may be considered sparse content. The amount of the virtual object(s)/content 506 may be one or more of a number, a size, a total area, etc., of objects in a given layer. As another example, an amount (e.g., an area) of the transparent area 504 that meets a threshold, e.g., is greater than or is greater than or equal to the threshold, may be indicative of sparse content. In one illustrative scenario, the four virtual objects representing the virtual object(s)/content 506, by way of example, may each comprise a separate layer in the image frame 502.

Thus, each layer may be individually rendered and then individually encoded and transmitted/provided for a display, despite the sparse content therein. Such handling of sparse content for layers leads to increased power consumption for memory and processors, increased encoder concurrency, and increased power for transmission / provision of rendered content for display.

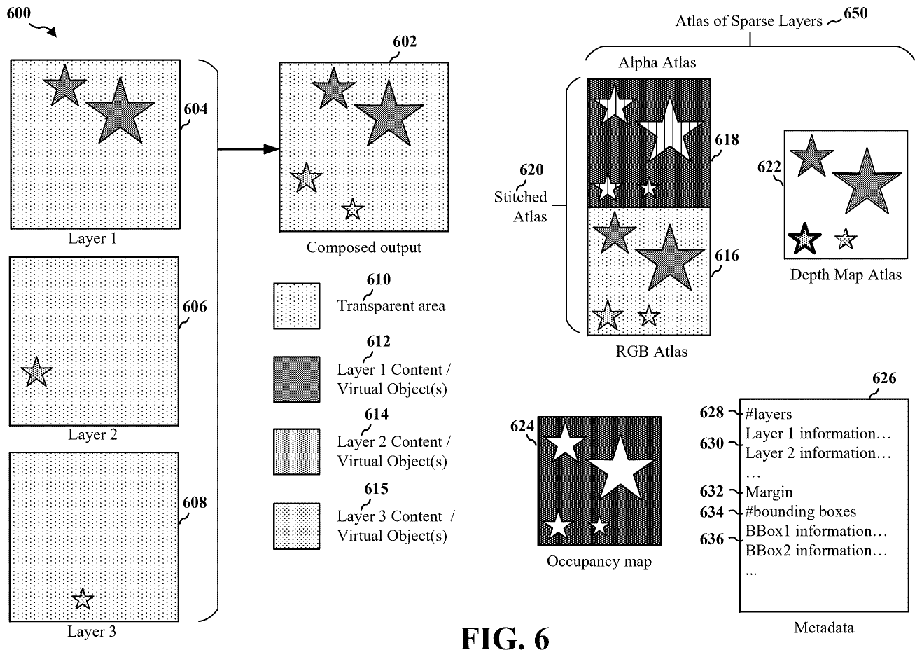

FIG. 6 illustrates a diagram 600 showing an example of an atlas of sparse layers, in accordance with one or more techniques of this disclosure. Aspects of diagram 800 may be performed by a display processor (e.g., the display processor 127/the sparse content atlas generator 198). Diagram 600 shows an image frame 602 that may comprise a number of layers. In aspects, the image frame 602 may be associated with image content from an application, e.g., a gaming engine and/or the like, and may be associated with XR content, such as split AR/MR content.

As shown, by way of example, a layer 604 (e.g., layer 1), a layer 606 (layer 2), and a layer 608 (layer 3) may comprise the image frame 602. Each of the layer 604, the layer 606, and the layer 608, as shown for the illustrative example in diagram 600, may include transparent area 610 (e.g., area without virtual content/objects), as well as virtual objects/content 612 for layer 1, virtual objects/content 614 for layer 2, and virtual objects/content 615 for layer 3. As the transparent area 610 comprises most of the layer 604, the layer 606, and the layer 608 (e.g., the virtual object(s)/content 612 for layer 1, the virtual object(s)/content 614 for layer 2, and the virtual object(s) / content 615 for layer 3 may fail to meet a threshold condition), these layers may be layers with sparse content. As noted herein, individual handling/operations for layers of images/image frames with sparse content layers may lead to inefficiencies.

Aspects herein provide for merging and/or rearranging a number the layers having sparse content (e.g., a set of layers, all layers, and/or the like) into a single atlas, such as an atlas 650 of sparse layers, after rendering so that the atlas 650 represents a single image frame for display processing, rather than processing multiple sparse frames individually. The atlas 650 of sparse layers may comprise an RGB atlas 616 and an alpha atlas 618 (which may be stacked/stitched, e.g., vertically or horizontally, as a stitched atlas 620 or a stitched RGBA atlas), and a depth map atlas 622. The RGB atlas 616 may comprise the sparse content from the layer 604, the layer 606, and the layer 608: the virtual object(s)/content 612 for layer 1, the virtual object(s)/content 614 for layer 2, and the virtual object(s)/content 615 for layer 3. In aspects, the virtual object(s)/content may be arranged in the RGB atlas 616 according to respective bounding boxes, of the virtual object(s)/content, in such a manner that the RGB atlas 616 is tightly packed (e.g., the bounding boxes may be arranged to take up the least, or approximately the least, area). The alpha atlas 618 may comprise alpha channel information associated with the virtual object(s)/content 612 for layer 1, the virtual object(s)/content 614 for layer 2, and the virtual object(s)/content 615 for layer 3. The depth map atlas 622 may comprise depth information/representations of the virtual object(s)/content 612 for layer 1, the virtual object(s)/content 614 for layer 2, and the virtual object(s)/content 615 for layer 3.

In aspects, the atlas 650 may have associated therewith an occupancy map 624 and metadata 626. In some aspects, an occupancy map may be a 2D matrix-like data structure which may have the same size as an associated RGBA atlas. In an occupancy map, each element may be 1 or 0, by way of example, depending on whether the corresponding element in the RGBA atlas has a virtual object or background, respectively. In aspects, the occupancy map 624 may be various types of data structures representative of first pixels that correspond to the virtual objects (e.g., the virtual object(s)/content 612 for layer 1, the virtual object(s)/content 614 for layer 2, and the virtual object(s)/content 615 for layer 3) that may be mapped to a first value (e.g., 1 or 0) and second pixels that correspond to locations outside of the virtual objects (e.g., the transparent area 610) that may be mapped to a second value (e.g., conversely 0 or 1). In aspects, information included for the occupancy map 624 may be utilized after encodes and decodes of boundary pixels (e.g., for the virtual object(s)/content 612 for layer 1, the virtual object(s)/content 614 for layer 2, and/or the virtual object(s)/content 615 for layer 3) that have been smoothed out (e.g., to prevent pixels which do not exist in the input frames from being generated inadvertently during display processing).

In aspects, the metadata 626 may include information associated with the atlas 650, such as but without limitation, a number of layers 628 represented by the atlas 650, layer information 630 for each layer in the atlas 650, a margin 632 (e.g., a value applied/added to dimensions of the bounding boxes for generation of the atlas 650, described in further detail herein), a number of bounding boxes 634 associated with the layers represented by the atlas 650, bounding box information 636 (e.g., locations, sizes, etc. of the bounding boxes), and/or the like. The layer information 630 may include information such as position, orientation, order of composition, plane parameters (which may be optional aspects based on the application utilizing a depth map) for warping, and/or the like, for each layer comprising the atlas 650. The bounding box information 636 may include information such as a corresponding layer index, an original position in a corresponding input layer, a position in the atlas 650, and/or the like, for each bounding box associated with the atlas 650.

Thus, aspects also enable the creation of an appropriate/a corresponding occupancy map (e.g., the occupancy map 624) of the virtual objects (e.g., the virtual object(s)/content 612 for layer 1, the virtual object(s)/content 614 for layer 2, and the virtual object(s)/content 615 for layer 3) in the layers, and three encoder sessions (e.g., for the RGB atlas 616 and the alpha atlas 618 (e.g., the stitched atlas 620) and the depth map atlas 622 with lossy/lossless compression, and for the occupancy map 624 with lossless compression), as well as creation and encoding of the metadata 626 with lossless compression, e.g., using an entropy encoding.

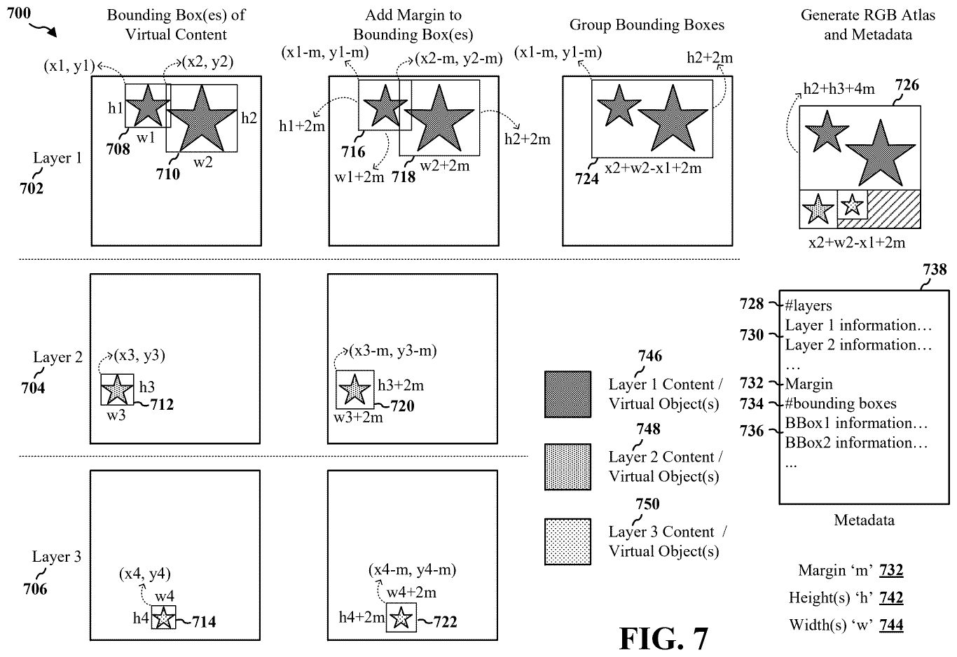

FIG. 7 illustrates a diagram 700 showing an example of generating an atlas of sparse layers, in accordance with one or more techniques of this disclosure. Aspects of diagram 700 may be performed by a display processor (e.g., the display processor 127/the sparse content atlas generator 198). Diagram 700 may be an aspect of diagram 600 in FIG. 6, and illustrates generation of an RGB atlas 726, and metadata 738 associated therewith, based on a first layer 702 (layer 1), a second layer 704 (layer 2), and a third layer 706 (layer 3), by way of illustrative example. Diagram 700 and bounding boxes therein may be described with respect to dimensions (e.g., height(s) ‘h’ 742 and width(s) ‘w’ 744) and applied/added margin ‘m’ 732.

Aspects herein enable the creation of an atlas of sparse layers using bounding boxes of all the layers while keeping a defined margin (e.g., approximately a smallest coding block size) between neighboring bounding boxes. For example, aspects enable identifying/generating bounding boxes for virtual objects (e.g., for virtual objects/content 746 for the first layer 702, virtual objects/content 748 for the second layer 704, and/or virtual objects/content 750 for the third layer 706), which may be either provided by an application, such a game engine, etc., or detected using a DL model(s), of all the sparse layers, and grouping overlapping bounding boxes of a layer into one bigger bounding box. For instance, to generate the RGB atlas 726, a display processor may be configured to bound, for each virtual object in each sparse layer of a set of sparse layers, a virtual object with a bounding box, of a set of bounding boxes, that surrounds the virtual object.

As one example, for the first layer 702, a bounding box 708 may bound (with minimal dimensions [h1, w1] and an original position (x1, y1)) a first portion of the virtual object(s)/content 746, and a bounding box 710 may bound (with minimal dimensions [h2, w2] and an original position (x2, y2)) a second portion of the virtual object(s)/content 746. For the second layer 704, a bounding box 712 may bound (with minimal dimensions [h3, w3] and an original position (x3, y3)) the virtual object(s)/content 748. For the third layer 706, and a bounding box 714 may bound (with minimal dimensions [h4, w4] and an original position (x4, y4)) the virtual object(s)/content 750. The margin ‘m’ 732 may be added to the height ‘h’ 742 and to the width ‘w’ 744 for each of the generated/identified bounding boxes, e.g., the bounding box 708, the bounding box 710, the bounding box 712, and the bounding box 714, to increase the corresponding dimensions to adjusted minimum dimensions.

Accordingly, the positions of the bounding boxes may also be adjusted to account for the margin ‘m’ 732, as shown, resulting in an adjusted bounding box 716 that may bound (with adjusted minimal dimensions [h1+2m, w1+2m] and an adjusted position (x1−m, y1−m)) the first portion of the virtual object(s)/content 746, and an adjusted bounding box 718 that may bound (with adjusted minimal dimensions [h2+2m, w2+2m] and an adjusted position (x2−m, y2−m)) the second portion of the virtual object(s)/content 746. For the second layer 704, an adjusted bounding box 720 that may bound (with adjusted minimal dimensions [h3+2m, w3+2m] and an adjusted position (x3−m, y3−m)) the virtual object(s)/content 748. For the third layer 706, and an adjusted bounding box 722 that may bound (with adjusted minimal dimensions [h4+2m, w4+2m] and an adjusted position (x4−m, y4−m)) the virtual object(s)/content 750. Aspects herein also provide for positioning references of bounding boxes to be other corners or portions thereof (e.g., a center) instead of a top left corner, as shown by way of example.

Regarding the first layer 702, having multiple portions of the virtual object(s)/content 746 in separate bounding boxes (e.g., the bounding box 708/the adjusted bounding box 716, the bounding box 710/the adjusted bounding box 718) that overlap each other, the overlapping, adjusted bounding boxes (e.g., the adjusted bounding box 716, the adjusted bounding box 718) may be grouped. As one example, to generate the RGB atlas 726, a display processor may be configured to group, for a subset of the set of sparse layers comprising overlapping bounding boxes, a set of overlapping bounding boxes in each sparse layer of the subset with an outer bounding box, of a set of outer bounding boxes, that surrounds the set of overlapping bounding boxes

For instance, to generate the RGB atlas 726, a display processor may be configured to bound, for a subset (e.g., the first layer 702 in diagram 700) of the set of sparse layers (e.g., the first layer 702, the second layer 704, and the third layer 706 in diagram 700) comprising overlapping bounding boxes (e.g., the adjusted bounding box 716, the adjusted bounding box 718), a set of overlapping bounding boxes (e.g., the adjusted bounding box 716, the adjusted bounding box 718) in each sparse layer of the subset with an outer bounding box 724, of a set of outer bounding boxes, that surrounds the set of overlapping bounding boxes. For instance, in the first layer 702, the outer bounding box 724 may bound (with adjusted minimal dimensions [h2+2m, w2+x2−x1+2m] and an adjusted position (x1−m, y1−m) (e.g., based on the adjusted bounding box 716 and the adjusted bounding box 718 so as to minimally bound with the margin ‘m’ 732 applied)) the first portion and the second portion of the virtual object(s)/content 746. Aspects also provide for a display processor to be configured to skip, or refrain from, the grouping of bounding boxes for layers (e.g., the second layer 704 and the third layer 706) that do not include overlapping bounding boxes.

The RGB atlas 726 may thus be generated by a display processor based on the aspects described in diagram 700, as one example. As shown, the RGB atlas 726 may include the virtual object(s)/content 746 in the outer bounding box 724, the virtual object(s)/content 748 in the adjusted bounding box 720, and the virtual object(s)/content 750 in the adjusted bounding box 722, and may have dimensions [h2+h3+4m, w2+x2−x1+2m] (e.g., a minimal bounding with the margin ‘m’ 732 applied). Accordingly, the merger of the set of sparse layers that includes the sparse content may be based on a smallest overall area for an arrangement of the set of bounding boxes. The metadata 738 may be generated to include information associated with the RGB atlas 726, such as but without limitation, a number of layers 728 represented by the RGB atlas 726 (e.g., 3 layers in diagram 700), layer information 730 for each layer in the RGB atlas 726, the margin ‘m’ 732 (e.g., a value applied/added to dimensions of the bounding boxes for generation of the RGB atlas 726), a number of bounding boxes 734 associated with the layers represented by the RGB atlas 726 (e.g., 4 bounding boxes in diagram 700), bounding box information 736 (e.g., locations (x, y), sizes [h, w], etc. of the bounding boxes), and/or the like. The layer information 730 may include information such as position, orientation, order of composition, plane parameters (which may be optional aspects based on the application utilizing a depth map) for warping, and/or the like, for each layer comprising the RGB atlas 726. The bounding box information 736 may include information such as a corresponding layer index (e.g., an index to the first layer 702 for the outer bounding box 724, an index to the second layer 704 for the adjusted bounding box 720, and an index to the third layer 706 for the adjusted bounding box 722), an original position (e.g., (x1, y1), (x2, y2), (x3, y3), (x4, y4)) in a corresponding input layer, a position in the RGB atlas 726, and/or the like, for each bounding box associated with the RGB atlas 726.

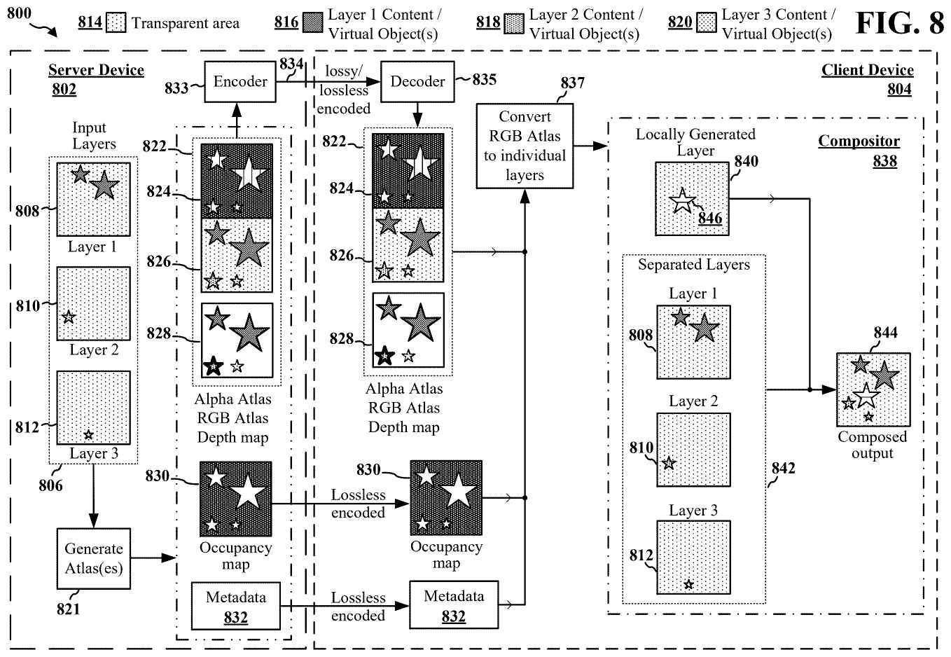

FIG. 8 illustrates a diagram 800 showing an example of a server-client pipeline for utilizing an atlas of sparse layers, in accordance with one or more techniques of this disclosure. Aspects of diagram 800 may be performed by a display processor (e.g., the display processor 127/the sparse content atlas generator 198) and/or by a display (e.g., the display(s) 131/the sparse content atlas generator 199). Diagram 800 may be an aspect of diagram 600 in FIG. 6 and/or of diagram 700 in FIG. 7, and illustrates a pipeline between a server device 802 and a client device 804 (e.g., for split AR/MR) in the context of an atlas 822 of sparse layers.

In aspects, the server device 802 may comprise a wireless communication device (e.g., a smart phone and/or the like), and the client device 804 may comprise a display (e.g., a headset, a mobile device display, XR display glasses, an automotive display, etc.). In some aspects, the server device 802 and the client device 804 may communicate, e.g., wirelessly, image content via the atlas 822 of sparse layers.

The server device 802 may receive input layers 806, e.g., comprising a first layer 808, a second layer 810, a third layer 812, etc., which may include sparse content, from an application (e.g., such as but not limited to, a gaming engine for XR), based on an amount of virtual objects/content therein meeting a threshold condition and/or based on an amount of transparent area 814 therein. The first layer 808 may include virtual objects/content 816, the second layer 810 may include virtual objects/content 818, and the third layer 812 may include virtual objects/content 820, each of which may represent sparse content for their respective layers in the illustrated example of diagram 800.

As similarly described above with respect to FIGS. 6, 7, the input layers 806 may be utilized, e.g., by a display processor, to generate (at 821) the atlas 822 of sparse layers. The atlas 822 may comprise an alpha atlas 824, an RGB atlas 826 (which may be stitched/stacked with the alpha atlas 824), and a depth map 828 of the RGB atlas 826. The atlas 822 may be associated with/include an occupancy map 830 (e.g., an aspect of the occupancy map 624 in FIG. 6) and metadata 832 (e.g., an aspect of the metadata 626 in FIG. 6 and/or the metadata 738 in FIG. 7). The atlas 822 may be lossy/lossless encoded, by an encoder 833, as a single frame/as a single encoding session, and an encoded atlas 834, e.g., an encoded representation of the atlas 822, may be transmitted/provided to the client device 804 (e.g., via Wi-Fi™, Bluetooth™, etc.). The occupancy map 830 and the metadata 832 may be losslessly encoded, in an encoding session(s) that is different than that used for the atlas 822, and be transmitted/provided to the client device 804 (e.g., via Wi-Fi™, Bluetooth™, etc.).

The client device 804 may receive the encoded atlas 834, the occupancy map 830 (e.g., as separately encoded from the encoded atlas 834), and the metadata 832 (e.g., as separately encoded from the encoded atlas 834), and perform respective decodes thereon. The client device 804 may be configured to decode the encoded atlas 834 using a decoder 835 to obtain the atlas 822 with the alpha atlas 824, the RGB atlas 826, and the depth map 828 of the RGB atlas 826. Utilizing a separate decode(s), the occupancy map 830 and the metadata 832 may be similarly obtained.

The client device 804 may be configured to convert (at 837) the RGB atlas 826 to individual, separated layers 842 based on the alpha atlas 824, the depth map 828, the occupancy map 830, and the metadata 832 (e.g., to obtain the first layer 808, the second layer 810, the third layer 812, etc.). In aspects, the client device 804 may comprise a compositor 838 that is configured to generate a local layer 840 (e.g., for split AR/MR content) having local virtual objects/content 846. The local layer 840 may be combined or composited at/by the compositor 838 with the first layer 808, the second layer 810, the third layer 812, etc., to generate composed output 844 (e.g., a composed layer in which the local layer 840 is included). The composed output 844 may be stored in a memory and/or provided for display to a user by the client device 804.

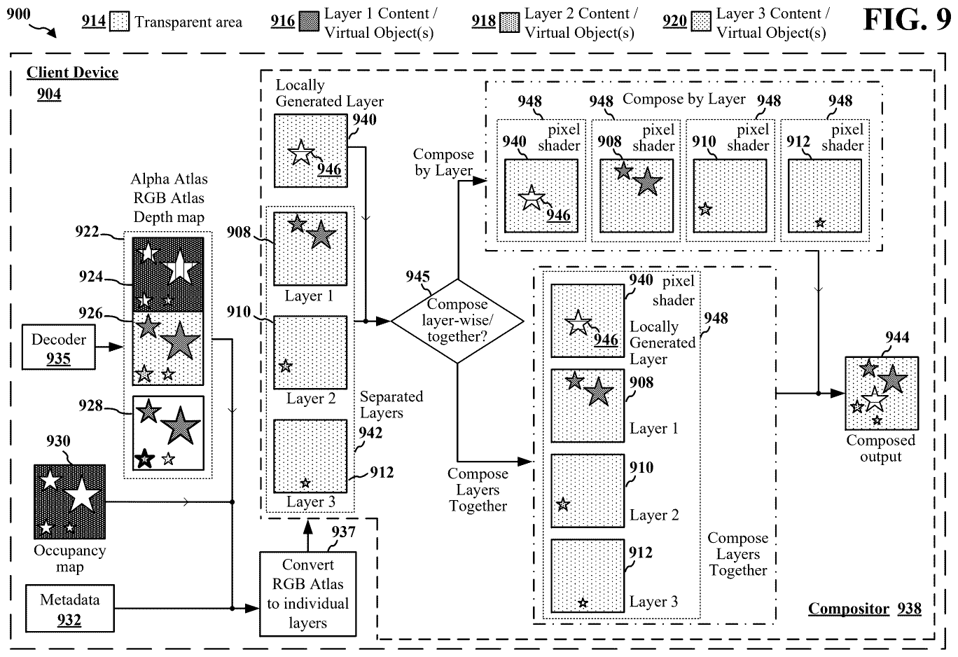

FIG. 9 illustrates a diagram 900 showing examples of layer composition for an atlas of sparse layers, in accordance with one or more techniques of this disclosure. Aspects of diagram 900 may be performed by a display processor (e.g., the display processor 127/the sparse content atlas generator 198) and/or by a display (e.g., the display(s) 131/the sparse content atlas generator 199). Diagram 900 may be an aspect of diagram 600 in FIG. 6, of diagram 700 in FIG. 7, and/or of diagram 800 in FIG. 8, and illustrates layer composition by a compositor 938 at a client device 904 (e.g., for split AR/MR) in the context of an atlas 922 of sparse layers.

As similarly described above for FIG. 8, in diagram 900, the client device 904 may receive an encoded atlas, an occupancy map, and metadata, and perform respective decodes thereon. The client device 904 may be configured to decode the encoded atlas using a decoder 935 to obtain the atlas 922 with an alpha atlas 924, an RGB atlas 926, and a depth map 928 of the RGB atlas 926. Utilizing a separate decode(s), the occupancy map 930 and the metadata 932 may be similarly obtained.

The client device 904 may be configured to convert (at 937) the RGB atlas 926 to individual, separated layers 942 based on the alpha atlas 924, the depth map 928, the occupancy map 930, and the metadata 932 (e.g., to obtain the first layer 908, the second layer 910, the third layer 912, etc.), which may include sparse content, from an application (e.g., such as but not limited to, a gaming engine for XR), based on an amount of virtual objects/content therein meeting a threshold condition and/or based on an amount of transparent area 914 therein. The first layer 908 may include virtual objects/content 916, the second layer 910 may include virtual objects/content 918, and the third layer 912 may include virtual objects/content 920, each of which may represent sparse content for their respective layers in the illustrated example of diagram 900.

In aspects, the compositor 938 may be configured to generate a local layer 940 (e.g., for split AR/MR content) having local virtual objects/content 946. The local layer 940 may be combined or composited at/by the compositor 938 with the first layer 908, the second layer 910, the third layer 912, etc., to generate composed output 944. In some aspects, the local layer 940 may be combined or composited at/by the compositor 938 with the first layer 908, the second layer 910, the third layer 912, etc., together or individually (e.g., composed by layer) by a pixel shader 948. The client device and/or the compositor 938 may be configured to determine (at 945) if the layers are to be composed individually or together. Based on individual composition or on composition together by the pixel shader 948, the composed output 944 may be generated. The composed output 944 may be stored in a memory and/or provided for display to a user by the client device 904.

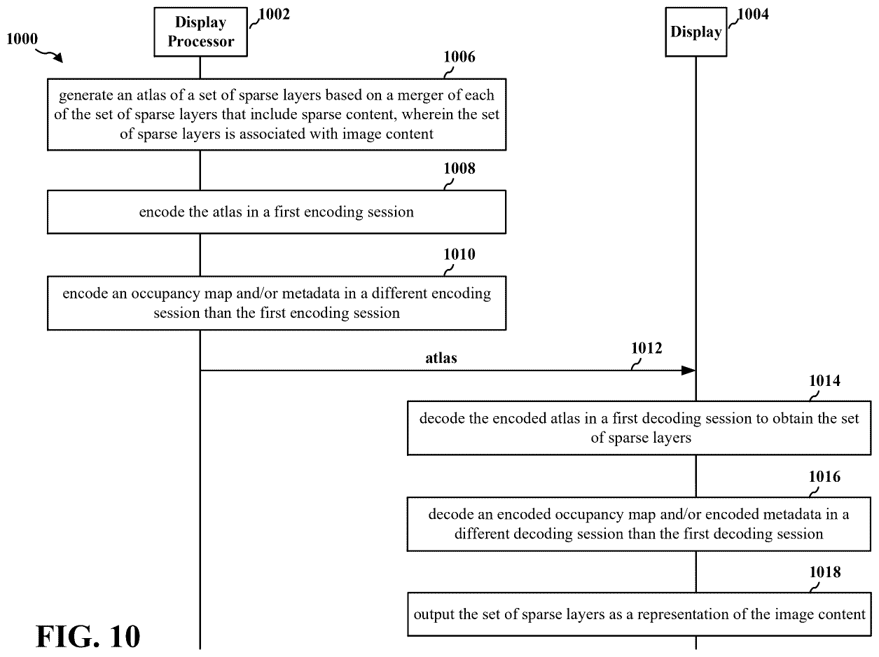

FIG. 10 is a call flow diagram 1000 illustrating example communications between a display processor 1002 and a display 1004 based on/associated with one or more techniques of this disclosure. In aspects, call flow diagram 1000 is described for multi-layer sparse content handling for split AR/MR. In an example, the display processor 1002 may be or include the display processor 127/the sparse content atlas generator 198. In an example, the display 1004 may be or include the display(s) 131/the sparse content atlas generator 199.

At 1006, the display processor 1002 may be configured to generate an atlas of a set of sparse layers based on a merger of each of the set of sparse layers that include sparse content, where the set of sparse layers is associated with image content. In some aspects, to generate (at 1006) the atlas 1012, the display processor 1002 may be configured to bound, for each virtual object in each sparse layer of the set of sparse layers, a virtual object with a bounding box, of a set of bounding boxes, that surrounds the virtual object. In such aspects, the atlas 1012 may comprise the set of bounding boxes and associated virtual objects. In aspects, each bounding box may comprise minimum dimensions by which a corresponding virtual object is respectively bounded. In such aspects, to generate the atlas 1012, the display processor 1002 may be configured to increase, for each virtual object in each sparse layer of the set of sparse layers, the minimum dimensions for a corresponding bounding box, to adjusted minimum dimensions, by a margin value. The merger of the set of sparse layers that includes the sparse content may be based on a smallest overall area for an arrangement of the set of bounding boxes. In some aspects, to generate (at 1006) the atlas 1012, the display processor 1002 may be configured to bound, for a subset of the set of sparse layers comprising overlapping bounding boxes, a set of overlapping bounding boxes in each sparse layer of the subset with an outer bounding box, of a set of outer bounding boxes, that surrounds the set of overlapping bounding boxes. In such aspects, the atlas 1012 may comprise the set of outer bounding boxes and the associated virtual objects. In some aspects, the atlas 1012 may comprise an occupancy map associated with virtual objects represented by the atlas 1012, and to generate (at 1006) the atlas 1012, the display processor 1002 may be configured to generate the occupancy map as a data structure representative of first pixels that correspond to the virtual objects mapped to a first value and second pixels that correspond to locations outside of the virtual objects mapped to a second value. In some aspects, the atlas 1012 comprises a set of metadata. The set of metadata may include at least one of: an indication of a number of the set of sparse layers, sparse layer information comprising at least one of a first position, an orientation, an order of composition, or a set of plane parameters for warping for each of the set of sparse layers, a margin added to bounding boxes, a number of bounding boxes that respectively surround virtual objects represented by the atlas 1012, bounding box information comprising at least one of a corresponding sparse layer index, a corresponding input layer index, an original position associated with an input layer, or a second position in the atlas 1012, and/or the like. In some aspects, the set of sparse layers may comprise a set of input layers associated with the image content, and to generate (at 1006) the atlas 1012, the display processor 1002 may be configured to generate the set of metadata based on at least one of the set of sparse layers associated with the image content or the bounding boxes. In some aspects, to generate (at 1006) the atlas 1012, the display processor 1002 may be configured to generate an alpha atlas based on alpha channel values associated with the atlas 1012, and/or to stitch the atlas 1012 together with the alpha atlas.

At 1008, the display processor 1002 may be configured to encode the atlas 1012 in a first encoding session. In some aspects, to encode (at 1008) the atlas 1012 in a first encoding session, the display processor 1002 may be configured to encode the atlas 1012 in the first encoding session with the alpha atlas. In some aspects, to encode (at 1008) the atlas 1012 in a first encoding session, the display processor 1002 may be configured to encode the atlas 1012 in the first encoding session and to encode the alpha atlas in a second encoding session. In some aspects, to encode (at 1008) the atlas 1012 in a first encoding session, the display processor 1002 may be configured to encode the atlas 1012 as a single frame. In some aspects, to encode (at 1008) the atlas 1012 in a first encoding session, the display processor 1002 may be configured to encode the atlas 1012 as lossy/lossless encoded.

At 1010, the display processor 1002 may be configured to encode an occupancy map and/or metadata in a different encoding session than the first encoding session. In some aspects, to encode (at 1010) an occupancy map and/or metadata, the display processor 1002 may be configured to encode based on a lossless encode. In some aspects, to encode (at 1010) metadata, the display processor 1002 may be configured to encode losslessly based on an entropy encode.

The display processor 1002 may be configured to transmit/provide (e.g., output), and the display 1004 may be configured to receive, the atlas 1012 as an encoded representation of the image content. In some aspects, to output the atlas 1012, as encoded, the display processor 1002 may be configured to output the encoded occupancy map and/or the encoded metadata. In some aspects, to output the atlas 1012, as encoded, the display processor 1002 may be configured to provide, for the display 1004, the atlas 1012 as the encoded representation of the image content and/or to store, in a memory, the atlas 1012 as the encoded representation of the image content.

At 1014, the display 1004 may be configured to decode the atlas 1012 (as encoded) in a first decoding session to obtain the set of sparse layers. In aspects, the encoded atlas may include an encoded alpha atlas, and the alpha atlas associated with the encoded alpha atlas may be based on alpha channel values associated with the encoded atlas that is stitched together with, or separately encoded from, the encoded atlas. In some aspects, to decode the encoded atlas in the first decoding session, the display 1004 may be configured to: decode the encoded atlas in the first decoding session with the encoded alpha atlas to obtain the alpha atlas, or decode the encoded atlas in the first decoding session and decode the encoded alpha atlas in a second decoding session to obtain the alpha atlas. In some aspects, to decode the encoded atlas in the first decoding session, the display 1004 may be configured to decode the encoded atlas as a single frame. In some aspects, a first number of decoding sessions comprising the first decoding session may be less than a second number of the set of sparse layers. The encoded atlas may include a set of virtual objects associated with the set of sparse layers, and each virtual object in each sparse layer of the set of sparse layers may be bound by a bounding box, of a set of bounding boxes, that surrounds the virtual object. In some aspects, each bounding box may comprise minimum dimensions by which a corresponding virtual object is respectively bounded. In some aspects each bounding box may comprise dimensions of a minimum value by which the corresponding virtual object is respectively bounded plus an increased margin value. In some aspects, the merger of the set of sparse layers that includes the sparse content may be based on a smallest overall area for an arrangement of the set of bounding boxes, and, for a subset of the set of sparse layers, the set of bounding boxes may comprise an outer bounding box that bounds two or more virtual objects in the set of virtual objects, where the outer bounding box may be based on a set of overlapping bounding boxes respectively associated with the two or more virtual objects in a sparse layer of the subset.

At 1016, the display 1004 may be configured to decode an encoded occupancy map and/or encoded metadata in a different decoding session than the first decoding session. The encoded atlas may comprise an encoded occupancy map associated with virtual objects represented by the encoded atlas, and the encoded occupancy map may comprise a data structure representative of first pixels that correspond to the virtual objects mapped to a first value and second pixels that correspond to locations outside of the virtual objects mapped to a second value. The encoded atlas may comprise an encoded set of metadata, and the encoded set of metadata may include at least one of: an indication of a number of the set of sparse layers, sparse layer information comprising at least one of a first position, an orientation, an order of composition, or a set of plane parameters for warping for each of the set of sparse layers, a margin added to bounding boxes, a number of bounding boxes that respectively surround virtual objects represented by the encoded atlas, bounding box information comprising at least one of a corresponding sparse layer index, a corresponding input layer index, an original position associated with an input layer, or a second position in the encoded atlas, and/or the like. In some aspects, the display 1004 may be configured to decode the encoded set of metadata in a different decoding session than the first decoding session to obtain a decoded set of metadata. In some aspects, the display 1004 may be configured to decode the encoded occupancy map in a different decoding session than the first decoding session.

At 1018, the display 1004 may be configured to output the set of sparse layers as a representation of the image content. In some aspects, to output the set of sparse layers as the representation of the image content, the display 1004 may be configured to compose the set of sparse layers, by a pixel shader of a compositor, individually or as a group to generate a composed layer. In some aspects, to output the set of sparse layers as the representation of the image content, the display 1004 may be configured to provide, for a display panel, the composed layer. In some aspects, to output the set of sparse layers as the representation of the image content, the display 1004 may be configured to store, in a memory, the composed layer. In aspects, to compose the set of sparse layers, by the pixel shader, individually or as the group, the display 1004 may be configured to compose the set of sparse layers in association with a locally-generated layer associated with the compositor, where the locally-generated layer is included in the composed layer.

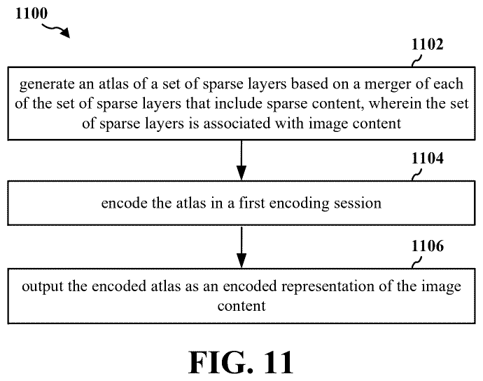

FIG. 11 is a flowchart 1100 of an example method of display processing in accordance with one or more techniques of this disclosure. The method may be performed by an apparatus, such as an apparatus for display processing, a display processing unit (DPU) or other display processor, a wireless communication device, and the like, as used in connection with the aspects of FIGS. 1-10. In an example, the method may be associated with multi-layer sparse content handling for split AR/MR at a device (e.g., the device 104). In an example, the method may be performed by the sparse content atlas generator 198.

At 1102, the apparatus may generate an atlas of a set of sparse layers based on a merger of each of the set of sparse layers that include sparse content, where the set of sparse layers is associated with image content. For example, referring to FIG. 10, at 1006, the display processor 1002 may be configured to generate (e.g., at 821) an atlas (e.g., 616, 650 in FIG. 6; 822, 826 in FIG. 8; 922, 926 in FIG. 9) of a set of sparse layers (e.g., 604, 606, 608 in FIG. 6; 702, 704, 706 in FIG. 7; 808, 810, 812 in FIG. 8; 908, 910, 912 in FIG. 9) based on a merger of each of the set of sparse layers (e.g., 604, 606, 608 in FIG. 6; 702, 704, 706 in FIG. 7; 808, 810, 812 in FIG. 8; 908, 910, 912 in FIG. 9) that include sparse content (e.g., 506 in FIG. 5; 612, 614, 615 in FIG. 6; 746, 748, 750 in FIG. 7; 816, 818, 820 in FIG. 8; 916, 918, 920 in FIG. 9), where the set of sparse layers (e.g., 604, 606, 608 in FIG. 6; 702, 704, 706 in FIG. 7; 808, 810, 812 in FIG. 8; 908, 910, 912 in FIG. 9) is associated with image content (e.g., of 502 in FIG. 5; of 602 in FIG. 6). In some aspects, to generate (at 1006 (e.g., at 821)) the atlas 1012 (e.g., 616, 650 in FIG. 6; 822, 826 in FIG. 8; 922, 926 in FIG. 9), the display processor 1002 may be configured to bound (e.g., for 700 in FIG. 7), for each virtual object (e.g., for 746, 748, 750 in FIG. 7) in each sparse layer of the set of sparse layers (e.g., 604, 606, 608 in FIG. 6; 702, 704, 706 in FIG. 7; 808, 810, 812 in FIG. 8; 908, 910, 912 in FIG. 9), a virtual object with a bounding box, of a set of bounding boxes (e.g., 708, 710, 712, 714 in FIG. 7), that surrounds the virtual object (e.g., for 746, 748, 750 in FIG. 7). In such aspects, the atlas 1012 (e.g., 616, 650 in FIG. 6; 822, 826 in FIG. 8; 922, 926 in FIG. 9) may comprise the set of bounding boxes (e.g., 708, 710, 712, 714 in FIG. 7) and associated virtual objects (e.g., for 746, 748, 750 in FIG. 7). In aspects, each bounding box (e.g., 708, 710, 712, 714 in FIG. 7) may comprise minimum dimensions (e.g., 742, 744, [h1, w1], [h2, w2], [h3, w3], [h4, w4] in FIG. 7) by which a corresponding virtual object (e.g., for 746, 748, 750 in FIG. 7) is respectively bounded. In such aspects, to generate (e.g., at 821) the atlas 1012 (e.g., 616, 650 in FIG. 6; 822, 826 in FIG. 8; 922, 926 in FIG. 9), the display processor 1002 may be configured to increase (e.g., Add Margin in FIG. 7), for each virtual object (e.g., for 746, 748, 750 in FIG. 7) in each sparse layer of the set of sparse layers (e.g., 604, 606, 608 in FIG. 6; 702, 704, 706 in FIG. 7; 808, 810, 812 in FIG. 8; 908, 910, 912 in FIG. 9), the minimum dimensions (e.g., 742, 744, [h1, w1], [h2, w2], [h3, w3], [h4, w4] in FIG. 7) for a corresponding bounding box (e.g., 708, 710, 712, 714 in FIG. 7), to adjusted minimum dimensions (e.g., [h1+2m, w1+2m] for 716, [h2+2m, w2+2m] for 718, [h 3+2m, w 3+2m] for 720, [h 4+2m, w 4+2m] for 722 in FIG. 7), by a margin value (e.g., m 732 in FIG. 7). The merger of the set of sparse layers (e.g., 604, 606, 608 in FIG. 6; 702, 704, 706 in FIG. 7; 808, 810, 812 in FIG. 8; 908, 910, 912 in FIG. 9) that includes the sparse content (e.g., 506 in FIG. 5; 612, 614, 615 in FIG. 6; 746, 748, 750 in FIG. 7; 816, 818, 820 in FIG. 8; 916, 918, 920 in FIG. 9) may be based on a smallest overall area (e.g., [h2+h3+4m, x2+w2-x1+2m] in FIG. 7) for an arrangement (e.g., in 726 in FIG. 7) of the set of bounding boxes (e.g., 708, 710, 712, 714, 716, 718, 720, 722, 724 in FIG. 7). In some aspects, to generate (at 1006 (e.g., at 821)) the atlas 1012 (e.g., 616, 650 in FIG. 6; 822, 826 in FIG. 8; 922, 926 in FIG. 9), the display processor 1002 may be configured to bound (e.g., for 700 in FIG. 7), for a subset (e.g., 702 in FIG. 7) of the set of sparse layers (e.g., 604, 606, 608 in FIG. 6; 702, 704, 706 in FIG. 7; 808, 810, 812 in FIG. 8; 908, 910, 912 in FIG. 9) comprising overlapping bounding boxes (e.g., 708/710, 716/718 in FIG. 7), a set of overlapping bounding boxes (e.g., 708/710, 716/718 in FIG. 7) in each sparse layer of the subset (e.g., 702 in FIG. 7) with an outer bounding box (e.g., 724 in FIG. 7), of a set of outer bounding boxes (e.g., 724 in FIG. 7), that surrounds the set of overlapping bounding boxes (e.g., 708/710, 716/718 in FIG. 7), e.g., two or more bounding boxes. In such aspects, the atlas 1012 (e.g., 616, 650 in FIG. 6; 822, 826 in FIG. 8; 922, 926 in FIG. 9) may comprise the set of outer bounding boxes (e.g., 724 in FIG. 7) and the associated virtual objects (e.g., for 746 in FIG. 7). In some aspects, the atlas 1012 (e.g., 616, 650 in FIG. 6; 822, 826 in FIG. 8; 922, 926 in FIG. 9) may comprise an occupancy map (e.g., 624 in FIG. 6; 830 in FIG. 8; 930 in FIG. 9) associated with virtual objects (e.g., of 506 in FIG. 5; of 612, 614, 615 in FIG. 6; of 746, 748, 750 in FIG. 7; of 816, 818, 820 in FIG. 8; of 916, 918, 920 in FIG. 9) represented by the atlas 1012 (e.g., 616, 650 in FIG. 6; 822, 826 in FIG. 8; 922, 926 in FIG. 9), and to generate (at 1006 (e.g., at 821)) the atlas 1012 (e.g., 616, 650 in FIG. 6; 822, 826 in FIG. 8; 922, 926 in FIG. 9), the display processor 1002 may be configured to generate the occupancy map (e.g., 624 in FIG. 6; 830 in FIG. 8; 930 in FIG. 9) as a data structure representative of first pixels that correspond to the virtual objects (e.g., of 506 in FIG. 5; of 612, 614, 615 in FIG. 6; of 746, 748, 750 in FIG. 7; of 816, 818, 820 in FIG. 8; of 916, 918, 920 in FIG. 9) mapped to a first value (e.g., 0/1) and second pixels that correspond to locations (e.g., 506 in FIG. 5; 610 in FIG. 6; 814 in FIG. 8; 914 in FIG. 9) outside of the virtual objects (e.g., of 506 in FIG. 5; of 612, 614, 615 in FIG. 6; of 746, 748, 750 in FIG. 7; of 816, 818, 820 in FIG. 8; of 916, 918, 920 in FIG. 9) mapped to a second value (e.g., 1/0). In some aspects, the atlas 1012 (e.g., 616, 650 in FIG. 6; 822, 826 in FIG. 8; 922, 926 in FIG. 9) comprises a set of metadata (e.g., 626 in FIG. 6; 738 in FIG. 7; 832 in FIG. 8; 932 in FIG. 9). The set of metadata (e.g., 626 in FIG. 6; 738 in FIG. 7; 832 in FIG. 8; 932 in FIG. 9) may include at least one of: an indication of a number (e.g., 628 in FIG. 6; 728 in FIG. 7) of the set of sparse layers (e.g., 604, 606, 608 in FIG. 6; 702, 704, 706 in FIG. 7; 808, 810, 812 in FIG. 8; 908, 910, 912 in FIG. 9), sparse layer information (e.g., 630 in FIG. 6; 730 in FIG. 7) comprising at least one of a first position, an orientation, an order of composition, or a set of plane parameters for warping for each of the set of sparse layers (e.g., 604, 606, 608 in FIG. 6; 702, 704, 706 in FIG. 7; 808, 810, 812 in FIG. 8; 908, 910, 912 in FIG. 9), a margin (e.g., m 732 in FIG. 7) added to bounding boxes (e.g., 708, 710, 712, 714, in FIG. 7), a number (e.g., 634 in FIG. 6; 734 in FIG. 7) of bounding boxes (e.g., 708, 710, 712, 714, 716, 718, 720, 722, 724 in FIG. 7) that respectively surround virtual objects represented by the atlas 1012 (e.g., 616, 650 in FIG. 6; 822, 826 in FIG. 8; 922, 926 in FIG. 9), bounding box information (e.g., 636 in FIG. 6; 736 in FIG. 7) comprising at least one of a corresponding sparse layer index, a corresponding input layer index, an original position associated with an input layer, or a second position in the atlas 1012 (e.g., 616, 650 in FIG. 6; 822, 826 in FIG. 8; 922, 926 in FIG. 9), and/or the like. In some aspects, the set of sparse layers (e.g., 604, 606, 608 in FIG. 6; 702, 704, 706 in FIG. 7; 808, 810, 812 in FIG. 8; 908, 910, 912 in FIG. 9) may comprise a set of input layers associated with the image content (e.g., of 502 in FIG. 5; of 602 in FIG. 6), and to generate (at 1006 (e.g., at 821)) the atlas 1012 (e.g., 616, 650 in FIG. 6; 822, 826 in FIG. 8; 922, 926 in FIG. 9), the display processor 1002 may be configured to generate the set of metadata (e.g., 626 in FIG. 6; 738 in FIG. 7; 832 in FIG. 8; 932 in FIG. 9) based on at least one of the set of sparse layers (e.g., 604, 606, 608 in FIG. 6; 702, 704, 706 in FIG. 7; 808, 810, 812 in FIG. 8; 908, 910, 912 in FIG. 9) associated with the image content (e.g., of 502 in FIG. 5; of 602 in FIG. 6) or the bounding boxes (e.g., 708, 710, 712, 714, 716, 718, 720, 722, 724 in FIG. 7). In some aspects, to generate (at 1006 (e.g., at 821)) the atlas 1012 (e.g., 616, 650 in FIG. 6; 822, 826 in FIG. 8; 922, 926 in FIG. 9), the display processor 1002 may be configured to generate an alpha atlas (e.g., 618 in FIG. 6; 824 in FIG,. 8; 924 in FIG. 9) based on alpha channel values associated with the atlas 1012 (e.g., 616, 650 in FIG. 6; 822, 826 in FIG. 8; 922, 926 in FIG. 9), and to stitch (e.g., 620 in FIG. 6) the atlas 1012 together with the alpha atlas (e.g., 618 in FIG. 6; 824 in FIG,. 8; 924 in FIG. 9). In an example, 1102 may be performed by the sparse content atlas generator 198.

At 1104, the apparatus may encode the atlas in a first encoding session. For example, referring to FIG. 10, at 1008, the display processor 1002 may be configured to encode the atlas 1012 (e.g., 616, 650 in FIG. 6; 822, 826 in FIG. 8; 922, 926 in FIG. 9) in a first encoding session (e.g., via 833 in FIG. 8). In some aspects, to encode (at 1008) the atlas 1012 (e.g., 616, 650 in FIG. 6; 822, 826 in FIG. 8; 922, 926 in FIG. 9) in a first encoding session (e.g., via 833 in FIG. 8), the display processor 1002 may be configured to encode the atlas 1012 (e.g., 616, 650 in FIG. 6; 822, 826 in FIG. 8; 922, 926 in FIG. 9) in the first encoding session (e.g., via 833 in FIG. 8) with the alpha atlas (e.g., 618 in FIG. 6; 824 in FIG,. 8; 924 in FIG. 9). In some aspects, to encode (at 1008) (e.g., via 833 in FIG. 8) the atlas 1012 (e.g., 616, 650 in FIG. 6; 822, 826 in FIG. 8; 922, 926 in FIG. 9) in a first encoding session (e.g., via 833 in FIG. 8), the display processor 1002 may be configured to encode (e.g., via 833 in FIG. 8) the atlas 1012 (e.g., 616, 650 in FIG. 6; 822, 826 in FIG. 8; 922, 926 in FIG. 9) as a single frame. In some aspects, to encode (at 1008) the atlas 1012 (e.g., 616, 650 in FIG. 6; 822, 826 in FIG. 8; 922, 926 in FIG. 9) in a first encoding session (e.g., via 833 in FIG. 8), the display processor 1002 may be configured to encode the atlas 1012 (e.g., 616, 650 in FIG. 6; 822, 826 in FIG. 8; 922, 926 in FIG. 9) as lossy/lossless encoded. At 1010, the display processor 1002 may be configured to encode an occupancy map (e.g., 624 in FIG. 6; 830 in FIG. 8; 930 in FIG. 9) and/or metadata (e.g., 626 in FIG. 6; 738 in FIG. 7; 832 in FIG. 8; 932 in FIG. 9) in a different encoding session (e.g., ‘Lossless encoded’ in FIG. 8) than the first encoding session (e.g., via 833 in FIG. 8). In some aspects, to encode (at 1010) an occupancy map (e.g., 624 in FIG. 6; 830 in FIG. 8; 930 in FIG. 9) and/or metadata (e.g., 626 in FIG. 6; 738 in FIG. 7; 832 in FIG. 8; 932 in FIG. 9), the display processor 1002 may be configured to encode based on a lossless encode (e.g., ‘Lossless encoded’ in FIG. 8). In some aspects, to encode (at 1010) metadata (e.g., 626 in FIG. 6; 738 in FIG. 7; 832 in FIG. 8; 932 in FIG. 9), the display processor 1002 may be configured to encode losslessly (e.g., ‘Lossless encoded’ in FIG. 8) based on an entropy encode. In an example, 1104 may be performed by the sparse content atlas generator 198.

At 1106, the apparatus may output the encoded atlas as an encoded representation of the image content. For example, referring to FIG. 10, the display processor 1002 may be configured to transmit/provide (e.g., output), and the display 1004 may be configured to receive, the atlas 1012 (e.g., 616, 650 in FIG. 6; 822, 826 in FIG. 8; 922, 926 in FIG. 9) as an encoded representation (e.g., via 833, 834 in FIG. 8) of the image content (e.g., of 502 in FIG. 5; of 602 in FIG. 6). In some aspects, to output the atlas 1012 (e.g., 616, 650 in FIG. 6; 822, 826 in FIG. 8; 922, 926 in FIG. 9), as encoded (e.g., via 833, 834 in FIG. 8), the display processor 1002 may be configured to output the encoded occupancy map (e.g., 624 in FIG. 6; 830 in FIG. 8; 930 in FIG. 9) and/or the encoded metadata (e.g., 626 in FIG. 6; 738 in FIG. 7; 832 in FIG. 8; 932 in FIG. 9). In some aspects, to output the atlas 1012 (e.g., 616, 650 in FIG. 6; 822, 826 in FIG. 8; 922, 926 in FIG. 9), as encoded (e.g., via 833, 834 in FIG. 8), the display processor 1002 may be configured to provide, for the display 1004, the atlas 1012 (e.g., 616, 650 in FIG. 6; 822, 826 in FIG. 8; 922, 926 in FIG. 9) as the encoded representation (e.g., via 833, 834 in FIG. 8) of the image content (e.g., of 502 in FIG. 5; of 602 in FIG. 6) and/or to store, in a memory, the atlas 1012 (e.g., 616, 650 in FIG. 6; 822, 826 in FIG. 8; 922, 926 in FIG. 9) as the encoded representation (e.g., via 833, 834 in FIG. 8) of the image content (e.g., of 502 in FIG. 5; of 602 in FIG. 6). In an example, 1106 may be performed by the sparse content atlas generator 198.

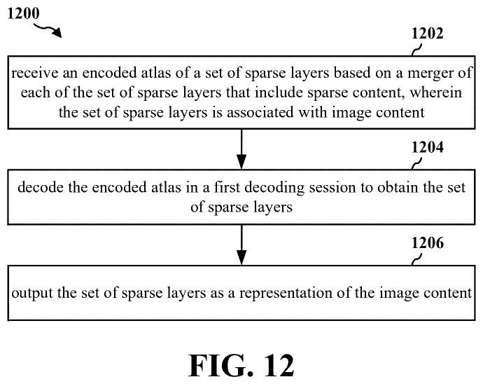

FIG. 12 is a flowchart 1200 of an example method of display processing in accordance with one or more techniques of this disclosure. The method may be performed by an apparatus, such as an apparatus for display processing, a display, a display controller, a display processing unit (DPU) or other display processor, a wireless communication device, and the like, as used in connection with the aspects of FIGS. 1-10. In an example, the method may be associated with multi-layer sparse content handling for split AR/MR at a device (e.g., the device 104). In an example, the method may be performed by the sparse content atlas generator 199.

At 1202, the apparatus may receive an encoded atlas of a set of sparse layers based on a merger of each of the set of sparse layers that include sparse content, where the set of sparse layers is associated with image content. For example, referring to FIG. 10, the display processor 1002 may be configured to transmit/provide (e.g., output), and the display 1004 may be configured to receive, the atlas 1012 (e.g., 616, 650 in FIG. 6; 822, 826 in FIG. 8; 922, 926 in FIG. 9) as an encoded representation (e.g., via 833, 834 in FIG. 8) of the image content (e.g., of 502 in FIG. 5; of 602 in FIG. 6). In some aspects, to output the atlas 1012 (e.g., 616, 650 in FIG. 6; 822, 826 in FIG. 8; 922, 926 in FIG. 9), as encoded (e.g., via 833, 834 in FIG. 8), the display processor 1002 may be configured to output the encoded occupancy map (e.g., 624 in FIG. 6; 830 in FIG. 8; 930 in FIG. 9) and/or the encoded metadata (e.g., 626 in FIG. 6; 738 in FIG. 7; 832 in FIG. 8; 932 in FIG. 9). In some aspects, to output the atlas 1012 (e.g., 616, 650 in FIG. 6; 822, 826 in FIG. 8; 922, 926 in FIG. 9), as encoded (e.g., via 833, 834 in FIG. 8), the display processor 1002 may be configured to provide, for the display 1004, the atlas 1012 (e.g., 616, 650 in FIG. 6; 822, 826 in FIG. 8; 922, 926 in FIG. 9) as the encoded representation (e.g., via 833, 834 in FIG. 8) of the image content (e.g., of 502 in FIG. 5; of 602 in FIG. 6) and/or to store, in a memory, the atlas 1012 (e.g., 616, 650 in FIG. 6; 822, 826 in FIG. 8; 922, 926 in FIG. 9) as the encoded representation (e.g., via 833, 834 in FIG. 8) of the image content (e.g., of 502 in FIG. 5; of 602 in FIG. 6). In an example, 1202 may be performed by the sparse content atlas generator 199.

At 1204, the apparatus may decode the encoded atlas in a first decoding session to obtain the set of sparse layers. For example, referring to FIG. 10, at 1014, the display 1004 may be configured to decode (e.g., via 835 in FIG. 8; via 935 in FIG. 9) the atlas 1012 (e.g., 616, 650 in FIG. 6; 822, 826 in FIG. 8; 922, 926 in FIG. 9) (as encoded (e.g., via 833, 834 in FIG. 8)) in a first decoding session (e.g., via 835 in FIG. 8; via 935 in FIG. 9) to obtain (e.g., at 837 in FIG. 8; at 937 in FIG. 9) the set of sparse layers (e.g., 604, 606, 608 in FIG. 6; 702, 704, 706 in FIG. 7; 808, 810, 812 in FIG. 8; 908, 910, 912 in FIG. 9). In aspects, the encoded atlas 1012 (e.g., 616, 650 in FIG. 6; 822, 826 in FIG. 8; 922, 926 in FIG. 9) (e.g., via 833, 834 in FIG. 8) may include an encoded alpha atlas (e.g., via 833, 834 in FIG. 8), and the alpha atlas (e.g., 618 in FIG. 6; 824 in FIG,. 8; 924 in FIG. 9) associated with the encoded alpha atlas (e.g., via 833, 834 in FIG. 8) may be based on alpha channel values associated with the encoded atlas (e.g., 616, 650 in FIG. 6; 822, 826 in FIG. 8; 922, 926 in FIG. 9) (e.g., via 833 in FIG. 8) that is stitched together (e.g., 620 in FIG. 6) with the encoded atlas (e.g., 616, 650 in FIG. 6; 822, 826 in FIG. 8; 922, 926 in FIG. 9) (e.g., via 833 in FIG. 8). In some aspects, to decode (e.g., via 835 in FIG. 8; via 935 in FIG. 9) the encoded atlas (e.g., 616, 650 in FIG. 6; 822, 826 in FIG. 8; 922, 926 in FIG. 9) (e.g., via 833 in FIG. 8) in the first decoding session (e.g., via 835 in FIG. 8; via 935 in FIG. 9), the display 1004 may be configured to decode (e.g., via 835 in FIG. 8; via 935 in FIG. 9) the encoded atlas (e.g., 616, 650 in FIG. 6; 822, 826 in FIG. 8; 922, 926 in FIG. 9) (e.g., via 833 in FIG. 8) in the first decoding session (e.g., via 835 in FIG. 8; via 935 in FIG. 9) with the encoded alpha atlas (e.g., 618 in FIG. 6; 824 in FIG,. 8; 924 in FIG. 9) (e.g., via 833 in FIG. 8) to obtain the alpha atlas (e.g., 618 in FIG. 6; 824 in FIG,. 8; 924 in FIG. 9). In some aspects, to decode (e.g., via 835 in FIG. 8; via 935 in FIG. 9) the encoded atlas (e.g., 616, 650 in FIG. 6; 822, 826 in FIG. 8; 922, 926 in FIG. 9) (e.g., via 833 in FIG. 8) in the first decoding session (e.g., via 835 in FIG. 8; via 935 in FIG. 9), the display 1004 may be configured to decode (e.g., via 835 in FIG. 8; via 935 in FIG. 9) the encoded atlas (e.g., 616, 650 in FIG. 6; 822, 826 in FIG. 8; 922, 926 in FIG. 9) (e.g., via 833 in FIG. 8) as a single frame. In some aspects, a first number of decoding sessions comprising the first decoding session (e.g., via 835 in FIG. 8; via 935 in FIG. 9) may be less than a second number of the set of sparse layers (e.g., 604, 606, 608 in FIG. 6; 702, 704, 706 in FIG. 7; 808, 810, 812 in FIG. 8; 908, 910, 912 in FIG. 9). The encoded atlas (e.g., 616, 650 in FIG. 6; 822, 826 in FIG. 8; 922, 926 in FIG. 9) (e.g., via 833 in FIG. 8) may include a set of virtual objects (e.g., of 506 in FIG. 5; of 612, 614, 615 in FIG. 6; of 746, 748, 750 in FIG. 7; of 816, 818, 820 in FIG. 8; of 916, 918, 920 in FIG. 9) associated with the set of sparse layers (e.g., 604, 606, 608 in FIG. 6; 702, 704, 706 in FIG. 7; 808, 810, 812 in FIG. 8; 908, 910, 912 in FIG. 9), and each virtual object in each sparse layer of the set of sparse layers (e.g., 604, 606, 608 in FIG. 6; 702, 704, 706 in FIG. 7; 808, 810, 812 in FIG. 8; 908, 910, 912 in FIG. 9) may be bound (e.g., for 700 in FIG. 7) by a bounding box, of a set of bounding boxes (e.g., 708, 710, 712, 714 in FIG. 7), that surrounds the virtual object (e.g., for 746, 748, 750 in FIG. 7). In some aspects, each bounding box(e.g., 708, 710, 712, 714 in FIG. 7) may comprise minimum dimensions (e.g., 742, 744, [h1, w1], [h2, w2], [h3, w3], [h4, w4] in FIG. 7) by which a corresponding virtual object (e.g., for 746, 748, 750 in FIG. 7) is respectively bounded. In some aspects each bounding box (e.g., 708, 710, 712, 714 in FIG. 7) may comprise dimensions (e.g., 742, 744, [h1, w1], [h2, w2], [h3, w3], [h4, w4] in FIG. 7) of a minimum value by which the corresponding virtual object (e.g., for 746, 748, 750 in FIG. 7) is respectively bounded plus an increased margin value (e.g., m 732 in FIG. 7) (e.g., [h1+2m, w1+2m] for 716, [h2+2m, w2+2m] for 718, [h3+2m, w3+2m] for 720, [h4+2m, w4+2m] for 722 in FIG. 7). In some aspects, the merger of the set of sparse layers (e.g., 604, 606, 608 in FIG. 6; 702, 704, 706 in FIG. 7; 808, 810, 812 in FIG. 8; 908, 910, 912 in FIG. 9) that includes the sparse content (e.g., 506 in FIG. 5; 612, 614, 615 in FIG. 6; 746, 748, 750 in FIG. 7; 816, 818, 820 in FIG. 8; 916, 918, 920 in FIG. 9) may be based on a smallest overall area (e.g., [h2+h3+4m, x2+w2−x1+2m] in FIG. 7) for an arrangement (e.g., in 726 in FIG. 7) of the set of bounding boxes (e.g., 708, 710, 712, 714, 716, 718, 720, 722, 724 in FIG. 7), and, for a subset (e.g., 702 in FIG. 7) of the set of sparse layers (e.g., 604, 606, 608 in FIG. 6; 702, 704, 706 in FIG. 7; 808, 810, 812 in FIG. 8; 908, 910, 912 in FIG. 9), the set of bounding boxes (e.g., 708, 710, 712, 714, 716, 718, 720, 722, 724 in FIG. 7) may comprise an outer bounding box (e.g., 724 in FIG. 7) that bounds two or more virtual objects (e.g., for 746 in FIG. 7) in the set of virtual objects (e.g., of 506 in FIG. 5; of 612, 614, 615 in FIG. 6; of 746, 748, 750 in FIG. 7; of 816, 818, 820 in FIG. 8; of 916, 918, 920 in FIG. 9), where the outer bounding box (e.g., 724 in FIG. 7) may be based on a set of overlapping bounding boxes (e.g., 708/710, 716/718 in FIG. 7) respectively associated with the two or more virtual objects (e.g., for 746 in FIG. 7) in a sparse layer of the subset (e.g., 702 in FIG. 7). At 1016, the display 1004 may be configured to decode an encoded occupancy map (e.g., 624 in FIG. 6; 830 in FIG. 8; 930 in FIG. 9) and/or encoded metadata (e.g., 626 in FIG. 6; 738 in FIG. 7; 832 in FIG. 8; 932 in FIG. 9) in a different decoding session than the first decoding session (e.g., via 835 in FIG. 8; via 935 in FIG. 9). The encoded atlas (e.g., 616, 650 in FIG. 6; 822, 826 in FIG. 8; 922, 926 in FIG. 9) (e.g., via 833 in FIG. 8) may comprise an encoded (e.g., ‘Lossless encoded’ in FIG. 8) occupancy map (e.g., 624 in FIG. 6; 830 in FIG. 8; 930 in FIG. 9) associated with virtual objects (e.g., of 506 in FIG. 5; of 612, 614, 615 in FIG. 6; of 746, 748, 750 in FIG. 7; of 816, 818, 820 in FIG. 8; of 916, 918, 920 in FIG. 9) represented by the encoded atlas (e.g., 616, 650 in FIG. 6; 822, 826 in FIG. 8; 922, 926 in FIG. 9) (e.g., via 833 in FIG. 8), and the encoded (e.g., ‘Lossless encoded’ in FIG. 8) occupancy map (e.g., 624 in FIG. 6; 830 in FIG. 8; 930 in FIG. 9) may comprise a data structure representative of first pixels that correspond to the virtual objects (e.g., of 506 in FIG. 5; of 612, 614, 615 in FIG. 6; of 746, 748, 750 in FIG. 7; of 816, 818, 820 in FIG. 8; of 916, 918, 920 in FIG. 9) mapped to a first value (e.g., 0/1) and second pixels that correspond to locations (e.g., 506 in FIG. 5; 610 in FIG. 6; 814 in FIG. 8; 914 in FIG. 9) outside of the virtual objects (e.g., of 506 in FIG. 5; of 612, 614, 615 in FIG. 6; of 746, 748, 750 in FIG. 7; of 816, 818, 820 in FIG. 8; of 916, 918, 920 in FIG. 9) mapped to a second value (e.g., 1/0). The encoded atlas (e.g., 616, 650 in FIG. 6; 822, 826 in FIG. 8; 922, 926 in FIG. 9) (e.g., via 833 in FIG. 8) may comprise an encoded set of metadata (e.g., 626 in FIG. 6; 738 in FIG. 7; 832 in FIG. 8; 932 in FIG. 9), and the encoded set of metadata (e.g., 626 in FIG. 6; 738 in FIG. 7; 832 in FIG. 8; 932 in FIG. 9) may include at least one of: an indication of a number (e.g., 628 in FIG. 6; 728 in FIG. 7) of the set of sparse layers (e.g., 604, 606, 608 in FIG. 6; 702, 704, 706 in FIG. 7; 808, 810, 812 in FIG. 8; 908, 910, 912 in FIG. 9), sparse layer information (e.g., 630 in FIG. 6; 730 in FIG. 7) comprising at least one of a first position, an orientation, an order of composition, or a set of plane parameters for warping for each of the set of sparse layers (e.g., 604, 606, 608 in FIG. 6; 702, 704, 706 in FIG. 7; 808, 810, 812 in FIG. 8; 908, 910, 912 in FIG. 9), a margin (e.g., m 732 in FIG. 7) added to bounding boxes (e.g., 720, 722, 724 in FIG. 7), a number (e.g., 634 in FIG. 6; 734 in FIG. 7) of bounding boxes (e.g., 708, 710, 712, 714, 716, 718, 720, 722, 724 in FIG. 7) that respectively surround virtual objects (e.g., of 506 in FIG. 5; of 612, 614, 615 in FIG. 6; of 746, 748, 750 in FIG. 7; of 816, 818, 820 in FIG. 8; of 916, 918, 920 in FIG. 9) represented by the encoded atlas (e.g., 616, 650 in FIG. 6; 822, 826 in FIG. 8; 922, 926 in FIG. 9) (e.g., via 833 in FIG. 8), bounding box information (e.g., 636 in FIG. 6; 736 in FIG. 7) comprising at least one of a corresponding sparse layer index, a corresponding input layer index, an original position associated with an input layer, or a second position in the encoded atlas (e.g., 616, 650 in FIG. 6; 822, 826 in FIG. 8; 922, 926 in FIG. 9) (e.g., via 833 in FIG. 8), and/or the like. In some aspects, the display 1004 may be configured to decode the encoded set of metadata (e.g., 626 in FIG. 6; 738 in FIG. 7; 832 in FIG. 8; 932 in FIG. 9) in a different decoding session than the first decoding session (e.g., via 835 in FIG. 8; via 935 in FIG. 9) to obtain a decoded set of metadata (e.g., 626 in FIG. 6; 738 in FIG. 7; 832 in FIG. 8; 932 in FIG. 9). In some aspects, the display 1004 may be configured to decode the encoded (e.g., ‘Lossless encoded’ in FIG. 8) occupancy map (e.g., 624 in FIG. 6; 830 in FIG. 8; 930 in FIG. 9) in a different decoding session than the first decoding session (e.g., via 835 in FIG. 8; via 935 in FIG. 9). In an example, 1204 may be performed by the sparse content atlas generator 199.

At 1206, the apparatus may output the set of sparse layers as a representation of the image content. For example, referring to FIG. 10, at 1018, the display 1004 may be configured to output the set of sparse layers (e.g., 604, 606, 608 in FIG. 6; 702, 704, 706 in FIG. 7; 808, 810, 812 in FIG. 8; 908, 910, 912 in FIG. 9) as a representation of the image content (e.g., of 502 in FIG. 5; of 602 in FIG. 6). In some aspects, to output the set of sparse layers (e.g., 604, 606, 608 in FIG. 6; 702, 704, 706 in FIG. 7; 808, 810, 812 in FIG. 8; 908, 910, 912 in FIG. 9) as the representation of the image content (e.g., of 502 in FIG. 5; of 602 in FIG. 6), the display 1004 may be configured to compose the set of sparse layers (e.g., 604, 606, 608 in FIG. 6; 702, 704, 706 in FIG. 7; 808, 810, 812 in FIG. 8; 908, 910, 912 in FIG. 9), by a pixel shader (e.g., 948 in FIG. 9) of a compositor (e.g., 838 in FIG. 8; 938 in FIG. 9), individually (e.g., ‘Compose by Layer’ in FIG. 9) or as a group (e.g., ‘Compose Layers Together’ in FIG. 9) to generate a composed layer (e.g., 844 in FIG. 8; 944 in FIG. 9). In some aspects, to output the set of sparse layers (e.g., 604, 606, 608 in FIG. 6; 702, 704, 706 in FIG. 7; 808, 810, 812 in FIG. 8; 908, 910, 912 in FIG. 9) as the representation of the image content (e.g., of 502 in FIG. 5; of 602 in FIG. 6), the display 1004 may be configured to provide, for a display panel, the composed layer (e.g., 844 in FIG. 8; 944 in FIG. 9). In some aspects, to output the set of sparse layers (e.g., 604, 606, 608 in FIG. 6; 702, 704, 706 in FIG. 7; 808, 810, 812 in FIG. 8; 908, 910, 912 in FIG. 9) as the representation of the image content (e.g., of 502 in FIG. 5; of 602 in FIG. 6), the display 1004 may be configured to store, in a memory, the composed layer (e.g., 844 in FIG. 8; 944 in FIG. 9). In aspects, to compose the set of sparse layers (e.g., 604, 606, 608 in FIG. 6; 702, 704, 706 in FIG. 7; 808, 810, 812 in FIG. 8; 908, 910, 912 in FIG. 9), by the pixel shader (e.g., 948 in FIG. 9), individually (e.g., ‘Compose by Layer’ in FIG. 9) or as the group (e.g., ‘Compose Layers Together’ in FIG. 9), the display 1004 may be configured to compose the set of sparse layers (e.g., 604, 606, 608 in FIG. 6; 702, 704, 706 in FIG. 7; 808, 810, 812 in FIG. 8; 908, 910, 912 in FIG. 9) in association with a locally-generated layer (e.g., 840 in FIG. 8; 940 in FIG. 9) associated with the compositor (e.g., 838 in FIG. 8; 938 in FIG. 9), where the locally-generated layer (e.g., 840 in FIG. 8; 940 in FIG. 9) is included in the composed layer (e.g., 844 in FIG. 8; 944 in FIG. 9). In an example, 1206 may be performed by the sparse content atlas generator 199.

In configurations, a method or an apparatus for display processing is provided. The apparatus may be a display processor, a DPU, a CPU (or other central processor), a display driver integrated circuit (DDIC), an apparatus for display processing, and/or some other processor that may perform display processing. In aspects, the apparatus may be the display processor 127 within the device 104, or may be some other hardware within the device 104 or another device. The apparatus, e.g., display processor 127, may include means for generating an atlas of a set of sparse layers based on a merger of each of the set of sparse layers that include sparse content, where the set of sparse layers is associated with image content. The apparatus, e.g., display processor 127, may further include means for encoding the atlas in a first encoding session; The apparatus, e.g., display processor 127, may further include means for outputting the encoded atlas as an encoded representation of the image content. The apparatus, e.g., display processor 127, may further include means for encoding an occupancy map in a different encoding session than the first encoding session.

In other configurations, a method or an apparatus for display processing is provided. The apparatus may be a display, a display controller, a display processor, a DPU, a CPU (or other central processor), a display driver integrated circuit (DDIC), an apparatus for display processing, and/or some other processor that may perform display processing. In aspects, the apparatus may be the display(s) 131 within the device 104, or may be some other hardware within the device 104 or another device. The apparatus, e.g., display(s) 131, may include means for receiving an encoded atlas of a set of sparse layers based on a merger of each of the set of sparse layers that include sparse content, where the set of sparse layers is associated with image content. The apparatus, e.g., display(s) 131, may include means for decoding the encoded atlas in a first decoding session to obtain the set of sparse layers. The apparatus, e.g., display(s) 131, may include means for outputting the set of sparse layers as a representation of the image content. The apparatus, e.g., display(s) 131, may include means for decoding the encoded occupancy map in a different decoding session than the first decoding session. The apparatus, e.g., display(s) 131, may include means for decoding the encoded set of metadata in a different decoding session than the first decoding session to obtain a decoded set of metadata.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.
Aspect 1 is a method of display processing, comprising: generating an atlas of a set of sparse layers based on a merger of each of the set of sparse layers that include sparse content, wherein the set of sparse layers is associated with image content; encoding the atlas in a first encoding session; and outputting the encoded atlas as an encoded representation of the image content.
Aspect 2 is the method of aspect 1, wherein generating the atlas includes: bounding, for each virtual object in each sparse layer of the set of sparse layers, a virtual object with a bounding box, of a set of bounding boxes, that surrounds the virtual object; wherein the atlas comprises the set of bounding boxes and associated virtual objects.
Aspect 3 is the method of aspect 2, wherein each bounding box comprises minimum dimensions by which a corresponding virtual object is respectively bounded; wherein generating the atlas includes: increasing, for each virtual object in each sparse layer of the set of sparse layers, the minimum dimensions for a corresponding bounding box, to adjusted minimum dimensions, by a margin value.
Aspect 4 is the method of aspect 3, wherein the merger of the set of sparse layers that includes the sparse content is based on a smallest overall area for an arrangement of the set of bounding boxes.
Aspect 5 is the method of any of aspects 2 to 4, wherein generating the atlas includes: bounding, for a subset of the set of sparse layers comprising overlapping bounding boxes, a set of overlapping bounding boxes in each sparse layer of the subset with an outer bounding box, of a set of outer bounding boxes, that surrounds the set of overlapping bounding boxes; wherein the atlas comprises the set of outer bounding boxes and the associated virtual objects.
Aspect 6 is the method of any of aspects 1 to 5, wherein the atlas comprises an occupancy map associated with virtual objects represented by the atlas; wherein generating the atlas includes: generating the occupancy map as a data structure representative of first pixels that correspond to the virtual objects mapped to a first value and second pixels that correspond to locations outside of the virtual objects mapped to a second value; the method further comprising: encoding the occupancy map in a different encoding session than the first encoding session; wherein outputting the encoded atlas includes outputting the encoded occupancy map.
Aspect 7 is the method of any of aspects 1 to 6, wherein the atlas comprises a set of metadata, wherein the set of metadata includes at least one of: an indication of a number of the set of sparse layers; sparse layer information comprising at least one of a first position, an orientation, an order of composition, or a set of plane parameters for warping for each of the set of sparse layers; a margin added to bounding boxes; a number of bounding boxes that respectively surround virtual objects represented by the atlas; or bounding box information comprising at least one of a corresponding sparse layer index, a corresponding input layer index, an original position associated with an input layer, or a second position in the atlas.
Aspect 8 is the method of aspect 7, wherein the set of sparse layers comprises a set of input layers associated with the image content; wherein generating the atlas includes: generating the set of metadata based on at least one of the set of sparse layers associated with the image content or the bounding boxes; the method further comprising: encoding the set of metadata in a different encoding session than the first encoding session; wherein outputting the encoded atlas includes outputting the encoded set of metadata.
Aspect 9 is the method of any of aspects 1 to 8, wherein generating the atlas includes at least one of: generating an alpha atlas based on alpha channel values associated with the atlas; or stitching the atlas together with the alpha atlas; wherein encoding the atlas in the first encoding session includes encoding the atlas in the first encoding session with the alpha atlas, or encoding the atlas in the first encoding session and encoding the alpha atlas in a second encoding session.
Aspect 10 is the method of any of aspects 1 to 9, wherein encoding the atlas in the first encoding session includes encoding the atlas as a single frame; or wherein a first number of encoding sessions comprising the first encoding session is less than a second number of the set of sparse layers.
Aspect 11 is the method of any of aspects 1 to 10, wherein outputting the encoded atlas as the encoded representation of the image content includes at least one of: providing, for a display panel, the encoded atlas as the encoded representation of the image content; or storing, in a memory, the encoded atlas as the encoded representation of the image content.
Aspect 12 is a method of display processing, comprising: receiving an encoded atlas of a set of sparse layers based on a merger of each of the set of sparse layers that include sparse content, wherein the set of sparse layers is associated with image content; decoding the encoded atlas in a first decoding session to obtain the set of sparse layers; and outputting the set of sparse layers as a representation of the image content.
Aspect 13 is the method of aspect 12, wherein the encoded atlas includes a set of virtual objects associated with the set of sparse layers; wherein each virtual object in each sparse layer of the set of sparse layers is bound by a bounding box, of a set of bounding boxes, that surrounds the virtual object.
Aspect 14 is the method of aspect 13, wherein at least one of: each bounding box comprises minimum dimensions by which a corresponding virtual object is respectively bounded, or each bounding box comprises dimensions of a minimum value by which the corresponding virtual object is respectively bounded plus an increased margin value; wherein the merger of the set of sparse layers that includes the sparse content is based on a smallest overall area for an arrangement of the set of bounding boxes; or wherein, for a subset of the set of sparse layers, the set of bounding boxes comprises an outer bounding box that bounds two or more virtual objects in the set of virtual objects, wherein the outer bounding box is based on a set of overlapping bounding boxes respectively associated with the two or more virtual objects in a sparse layer of the subset.
Aspect 15 is the method of any of aspects 12 to 14, wherein the encoded atlas comprises an encoded occupancy map associated with virtual objects represented by the encoded atlas, wherein the encoded occupancy map comprises a data structure representative of first pixels that correspond to the virtual objects mapped to a first value and second pixels that correspond to locations outside of the virtual objects mapped to a second value; wherein the method further comprises: decoding the encoded occupancy map in a different decoding session than the first decoding session; wherein outputting the set of sparse layers includes outputting the decoded occupancy map.
Aspect 16 is the method of any of aspects 12 to 15, wherein the encoded atlas comprises an encoded set of metadata, wherein the encoded set of metadata includes at least one of: an indication of a number of the set of sparse layers; sparse layer information comprising at least one of a first position, an orientation, an order of composition, or a set of plane parameters for warping for each of the set of sparse layers; a margin added to bounding boxes; a number of bounding boxes that respectively surround virtual objects represented by the encoded atlas; or bounding box information comprising at least one of a corresponding sparse layer index, a corresponding input layer index, an original position associated with an input layer, or a second position in the encoded atlas; wherein the method further comprises: decoding the encoded set of metadata in a different decoding session than the first encoding session to obtain the set of metadata; wherein outputting the set of sparse layers includes outputting the decoded set of metadata.
Aspect 17 is the method of any of aspects 12 to 16, wherein the encoded atlas includes an encoded alpha atlas, wherein an alphas atlas associated with the encoded alpha atlas is based on alpha channel values associated with the encoded atlas that is stitched together with, or separately encoded from, the encoded atlas, wherein decoding the encoded atlas in the first decoding session includes decoding the encoded atlas in the first encoding session with the encoded alpha atlas to obtain the alpha atlas, or decoding the encoded atlas in the first decoding session and decoding the encoded alpha atlas in a second decoding session to obtain the alpha atlas; wherein decoding the encoded atlas in the first decoding session includes decoding the encoded atlas as a single frame; or wherein a first number of decoding sessions comprising the first decoding session is less than a second number of the set of sparse layers.
Aspect 18 is the method of any of aspects 12 to 17, wherein outputting the set of sparse layers as the representation of the image content includes at least one of: composing the set of sparse layers, by a pixel shader of a compositor, individually or as a group to generate a composed layer; providing, for a display panel, the composed layer; or storing, in a memory, the composed layer.
Aspect 19 is the method of aspect 18, wherein composing the set of sparse layers, by the pixel shader, individually or as the group includes at least one of: composing the set of sparse layers in association with a locally-generated layer associated with the compositor, wherein the locally-generated layer is included in the composed layer.
Aspect 20 is an apparatus for display processing comprising a processor coupled to a memory and, based on information stored in the memory, the processor is configured to implement a method as in any of aspects 1-19.
Aspect 21 may be combined with aspect 20 and comprises that the apparatus is a wireless communication device.
Aspect 22 is an apparatus for display processing comprising means for implementing a method as in any of aspects 1-19.
Aspect 23 is a computer-readable medium (e.g., a non-transitory computer readable-medium) storing computer executable code, the computer executable code, when executed by a processor, causes the processor to implement a method as in any of aspects 1-19.

Various aspects have been described herein. These and other aspects are within the scope of the following claims.

What is claimed is:

1. An apparatus for display processing, comprising:
a memory; and
a processor coupled to the memory and, based on information stored in the memory, the processor is configured to:
generate an atlas of a set of sparse layers based on a merger of each of the set of sparse layers that include sparse content, wherein the set of sparse layers is associated with image content;
encode the atlas in a first encoding session; and
output the encoded atlas as an encoded representation of the image content.

2. The apparatus of claim 1, wherein to generate the atlas, the processor is configured to:
bound, for each virtual object in each sparse layer of the set of sparse layers, a virtual object with a bounding box, of a set of bounding boxes, that surrounds the virtual object;
wherein the atlas comprises the set of bounding boxes and associated virtual objects.

3. The apparatus of claim 2, wherein each bounding box comprises minimum dimensions by which a corresponding virtual object is respectively bounded;
wherein to generate the atlas, the processor is configured to:
increase, for each virtual object in each sparse layer of the set of sparse layers, the minimum dimensions for a corresponding bounding box, to adjusted minimum dimensions, by a margin value.

4. The apparatus of claim 3, wherein the merger of the set of sparse layers that includes the sparse content is based on a smallest overall area for an arrangement of the set of bounding boxes.

5. The apparatus of claim 2, wherein to generate the atlas, the processor is configured to:
bound, for a subset of the set of sparse layers comprising overlapping bounding boxes, a set of overlapping bounding boxes in each sparse layer of the subset with an outer bounding box, of a set of outer bounding boxes, that surrounds the set of overlapping bounding boxes;
wherein the atlas comprises the set of outer bounding boxes and the associated virtual objects.

6. The apparatus of claim 1, wherein the atlas comprises an occupancy map associated with virtual objects represented by the atlas;
wherein to generate the atlas, the processor is configured to:
generate the occupancy map as a data structure representative of first pixels that correspond to the virtual objects mapped to a first value and second pixels that correspond to locations outside of the virtual objects mapped to a second value;
wherein the processor is further configured to:
encode the occupancy map in a different encoding session than the first encoding session;
wherein to output the encoded atlas, the processor is configured to output the encoded occupancy map.

7. The apparatus of claim 1, wherein the atlas comprises a set of metadata, wherein the set of metadata includes at least one of:
an indication of a number of the set of sparse layers;
sparse layer information comprising at least one of a first position, an orientation, an order of composition, or a set of plane parameters for warping for each of the set of sparse layers;
a margin added to bounding boxes;
a number of bounding boxes that respectively surround virtual objects represented by the atlas; or
bounding box information comprising at least one of a corresponding sparse layer index, a corresponding input layer index, an original position associated with an input layer, or a second position in the atlas.

8. The apparatus of claim 7, wherein the set of sparse layers comprises a set of input layers associated with the image content;
wherein to generate the atlas, the processor is configured to:
generate the set of metadata based on at least one of the set of sparse layers associated with the image content or the bounding boxes;
wherein the processor is further configured to:
encode the set of metadata in a different encoding session than the first encoding session;
wherein to output the encoded atlas, the processor is configured to output the encoded set of metadata.

9. The apparatus of claim 1, wherein to generate the atlas, the processor is configured to perform at least one of:
generate an alpha atlas based on alpha channel values associated with the atlas; or
stitch the atlas together with the alpha atlas;
wherein to encode the atlas in the first encoding session, the processor is configured to: encode the atlas in the first encoding session with the alpha atlas, or to encode the atlas in the first encoding session and encode the alpha atlas in a second encoding session.

10. The apparatus of claim 1, wherein to encode the atlas in the first encoding session, the processor is configured to encode the atlas as a single frame; or
wherein a first number of encoding sessions comprising the first encoding session is less than a second number of the set of sparse layers.

11. The apparatus of claim 1, wherein to output the encoded atlas as the encoded representation of the image content, the processor is configured to perform at least one of:
provide, for a display panel, the encoded atlas as the encoded representation of the image content; or
store, in the memory, the encoded atlas as the encoded representation of the image content.

12. An apparatus for display processing, comprising:
a memory; and
a processor coupled to the memory and, based on information stored in the memory, the processor is configured to:
receive an encoded atlas of a set of sparse layers based on a merger of each of the set of sparse layers that include sparse content, wherein the set of sparse layers is associated with image content;
decode the encoded atlas in a first decoding session to obtain the set of sparse layers; and
output the set of sparse layers as a representation of the image content.

13. The apparatus of claim 12, wherein the encoded atlas includes a set of virtual objects associated with the set of sparse layers;
wherein each virtual object in each sparse layer of the set of sparse layers is bound by a bounding box, of a set of bounding boxes, that surrounds the virtual object.

14. The apparatus of claim 13, wherein at least one of:
each bounding box comprises minimum dimensions by which a corresponding virtual object is respectively bounded, or
each bounding box comprises dimensions of a minimum value by which the corresponding virtual object is respectively bounded plus an increased margin value;
wherein the merger of the set of sparse layers that includes the sparse content is based on a smallest overall area for an arrangement of the set of bounding boxes; or
wherein, for a subset of the set of sparse layers, the set of bounding boxes comprises an outer bounding box that bounds two or more virtual objects in the set of virtual objects, wherein the outer bounding box is based on a set of overlapping bounding boxes respectively associated with the two or more virtual objects in a sparse layer of the subset.

15. The apparatus of claim 12, wherein the encoded atlas comprises an encoded occupancy map associated with virtual objects represented by the encoded atlas, wherein the encoded occupancy map comprises a data structure representative of first pixels that correspond to the virtual objects mapped to a first value and second pixels that correspond to locations outside of the virtual objects mapped to a second value;
wherein the processor is configured further to:
decode the encoded occupancy map in a different decoding session than the first decoding session;
wherein to output the set of sparse layers, the processor is configured to output the decoded occupancy map.

16. The apparatus of claim 12, wherein the encoded atlas comprises an encoded set of metadata, wherein the encoded set of metadata includes at least one of:
an indication of a number of the set of sparse layers;
sparse layer information comprising at least one of a first position, an orientation, an order of composition, or a set of plane parameters for warping for each of the set of sparse layers;
a margin added to bounding boxes;
a number of bounding boxes that respectively surround virtual objects represented by the encoded atlas; or
bounding box information comprising at least one of a corresponding sparse layer index, a corresponding input layer index, an original position associated with an input layer, or a second position in the encoded atlas;
wherein the processor is further configured to:
decode the encoded set of metadata in a different decoding session than the first decoding session to obtain a decoded of metadata;
wherein to output the set of sparse layers, the processor is configured to output the decoded set of metadata.

17. The apparatus of claim 12, wherein the encoded atlas includes an encoded alpha atlas, wherein an alpha atlas associated with the encoded alpha atlas is based on alpha channel values associated with the encoded atlas that is stitched together with, or separately encoded from, the encoded atlas,
wherein to decode the encoded atlas in the first decoding session, the processor is configured to: decode the encoded atlas in the first decoding session with the encoded alpha atlas to obtain the alpha atlas, or decode the encoded atlas in the first decoding session and decode the encoded alpha atlas in a second decoding session to obtain the alpha atlas;
wherein to decode the encoded atlas in the first decoding session, the processor is configured to decode the encoded atlas as a single frame; or
wherein a first number of decoding sessions comprising the first decoding session is less than a second number of the set of sparse layers.

18. The apparatus of claim 12, wherein to output the set of sparse layers as the representation of the image content, the processor is configured to perform at least one of:
compose the set of sparse layers, by a pixel shader of a compositor, individually or as a group to generate a composed layer;
provide, for a display panel, the composed layer; or
store, in the memory, the composed layer.

19. The apparatus of claim 18, wherein to compose the set of sparse layers, by the pixel shader, individually or as the group, the processor is configured to:
compose the set of sparse layers in association with a locally-generated layer associated with the compositor, wherein the locally-generated layer is included in the composed layer.

20. A method of display processing, comprising:
generating an atlas of a set of sparse layers based on a merger of each of the set of sparse layers that include sparse content, wherein the set of sparse layers is associated with image content;
encoding the atlas in a first encoding session; and
outputting the encoded atlas as an encoded representation of the image content.
